(19) United States
(12) Patent Application Publication
(10) Pub. No.: US 2026/0087581 A1
(43) Pub. Date: Mar. 26, 2026

(54) GRAPHICS PROCESSING

(71) Applicant: Arm Limited, Cambridge (GB)

(72) Inventor: Frank Klaeboe Langtind, Melhus (NO)

(73) Assignee: Arm Limited, Cambridge (GB)

(21) Appl. No.: 18/897,848

(22) Filed: Sep. 26, 2024

(51) Int. Cl. G06T 1/20

(52) U.S. Cl. CPC G06T 1/20

(57) ABSTRACT

A graphics processor that executes a tile-based graphics processing pipeline. The graphics processing pipeline comprises a sequence of one or more geometry processing stages to perform geometry processing, a binning stage that generates data structures for identifying geometry to be processed for respective rendering tiles of a render output being generated, and a rendering stage for rendering tiles of a render output being generated. Some of the geometry processing of the graphics processing pipeline being executed can be deferred until the rendering stage. When generating a render output an amount of geometry processing to be performed at the rendering stage is tracked for each region of a plurality of regions that the render output has been divided into, and when the amount of geometry processing to be performed at the rendering stage for a region reaches a threshold value, the rendering of geometry for the region is triggered.

### BACKGROUND

The technology described herein relates to graphics processing, and in particular to tile-based graphics processing.

Graphics processing is normally carried out by first splitting a scene (e.g. a 3D model) to be rendered (e.g. for display) into a number of similar basic components or “primitives”, which primitives are then subjected to the desired graphics processing operations. The graphics primitives are usually in the form of simple polygons such as triangles, quadrilaterals, points, lines or groups thereof.

Each primitive is usually defined by and represented as a set of vertices (e.g. three vertices in the case of a triangular primitive). The vertices that are to be used for the primitives will have respective sets of vertex data defining the vertices, e.g. the relevant attributes for each of the vertices. These attributes will typically include position data and other, non-position data (varyings), e.g. defining colour, light, normal, texture coordinates, etc., for the vertex in question.

In tile-based graphics processing, the two-dimensional graphics processing output, such as an output frame to be displayed, is generated (rendered) as a plurality of smaller area regions, usually referred to as “tiles”. The output is typically divided (by area) into regularly-sized and shaped rendering tiles (they are usually e.g. squares or rectangles). The tiles are each rendered separately (e.g. one after another). The rendered tiles are then combined to provide the complete output (e.g. frame for display).

When performing tile-based graphics processing, there will normally be some initial geometry processing, such as vertex processing (vertex shading) of attributes for vertices to be used for primitives for the output being generated, to generate geometry (and other) data required for rendering the graphics processing output.

The geometry processing will then be followed by a tiling/binning process that generates appropriate data structures for determining which geometry (e.g. primitives) needs to be processed for respective rendering tiles of the output being generated.

(In tile-based graphics processing, it is usually desirable to be able to (try to) identify the geometry (e.g. primitives) that need to be processed for a given rendering tile (so as to avoid unnecessarily processing geometry that does not actually apply to a rendering tile). To facilitate this, in tile-based graphics processing, there is usually a tiling/binning process that is performed that generates appropriate data structures, such as lists of primitives that apply to a tile or tiles, for use then to identify geometry that need to be processed for a respective rendering tile.)

Once the binning/tiling process has generated the necessary data structures for identifying geometry to be processed for respective tiles of the output, the geometry can then be, and will be, subjected to appropriate rendering/fragment processing. This may comprise, for example, rasterising primitives to be processed to fragments, fragment shading of the fragments, and/or performing ray tracing operations. This operation is performed on a tile-by-tile basis, using the data structures generated by the tiling/binning process to identify the geometry (e.g. primitives) that need to be processed for a respective rendering tile.

The rendered tiles may then be combined appropriately to provide the overall output (e.g. frame for display).

The Applicants believe that there remains scope for improvements to the operation of tile-based graphics processors and tile-based graphics processing.

### BRIEF DESCRIPTION OF THE DRAWINGS

Embodiments of the technology described herein will now be described by way of example only and with reference to the accompanying drawings, in which:

FIG. 1 shows an exemplary data processing system in which the technology described herein may be implemented;

FIG. 2 shows an exemplary graphics processing pipeline;

FIG. 3 shows schematically a graphics processor that may be operated in accordance with the technology described herein;

FIG. 4 shows the geometry processing pipeline of the graphics processor of FIG. 3 in more detail;

FIG. 5 shows a distributed binning core of the graphics processor of FIG. 3 in more detail;

FIG. 6 is a flowchart showing the operation of a distributed binning core of the graphics processor;

FIG. 7 shows an exemplary binning data structure;

FIG. 8 shows a deferred shading control unit;

FIGS. 9 and 10 are flowcharts showing the operation of the deferred shading control unit;

FIGS. 11, 12, 13 and 14 show the use of memory heaps;

FIG. 15 shows the layout of a geometry buffer;

FIGS. 16 and 17 show exemplary binning data structures;

FIG. 18 shows a geometry tracking unit in an embodiment;

FIG. 19 shows the operation of the geometry tracking unit in an embodiment; and

FIGS. 20 to 23 illustrate the operation of the graphics processor in an embodiment.

Like reference numerals are used for like features in the Figures, where appropriate.

### DETAILED DESCRIPTION

A first embodiment of the technology described herein comprises a method of operating a graphics processor when executing a tile-based graphics processing pipeline to generate an output, the graphics processing pipeline being executed comprising:
a sequence of one or more geometry processing stages to perform geometry processing;
a binning stage that generates data structures for identifying geometry to be processed for respective rendering tiles of a render output being generated; and
a rendering stage for rendering tiles of a render output being generated;
wherein:
   some of the geometry processing of the sequence of one or more geometry processing stages of the graphics processing pipeline being executed can be deferred until the rendering stage for geometry being processed;
the method comprising:
   when generating a render output:
   for each region of a plurality of regions that the render output has been divided into, tracking an amount of geometry processing to be performed at the rendering stage for the region; and
   when the amount of geometry processing to be performed at the rendering stage for a region reaches a threshold value, triggering the rendering of geometry for the region.

A second embodiment of the technology described herein comprises a graphics processor comprising:
processing circuits configured to execute a tile-based graphics processing pipeline to generate an output, the graphics processing pipeline being executed comprising:
A sequence of one or more geometry processing stages to perform geometry processing;
a binning stage that generates data structures for identifying geometry to be processed for respective rendering tiles of a render output being generated; and
a rendering stage for rendering tiles of a render output being generated;
wherein:
   some of the geometry processing of the sequence of one or more geometry processing stages of the graphics processing pipeline being executed can be deferred until the rendering stage for geometry being processed;
   the graphics processor further comprising:
   a processing circuit configured to, when the graphics processor is generating a render output:
   track, for each region of a plurality of regions that the render output has been divided into, an amount of geometry processing to be performed at the rendering stage for the region; and
   when the amount of geometry processing to be performed at the rendering stage for a region reaches a threshold value, trigger the rendering of geometry for the region.

The technology described herein relates to tile-based graphics processing.

In the technology described herein geometry processing for geometry being processed can be deferred until the rendering stage.

The Applicants have recognised in this regard that, as will be discussed further below, not all of the geometry processing for geometry to be processed for a render output needs to be performed in advance of and for the binning/tiling stage in a tile-based graphics processing pipeline, but rather some of that processing can, where appropriate, be deferred until the rendering/fragment processing stage of the graphics processing pipeline (and, e.g., and in an embodiment, until it has been determined that the geometry in question actually applies to a rendering tile).

By deferring geometry processing to the rendering stage, the need to store the result of that processing from the geometry processing stage until it is required by the rendering stage is avoided.

The Applicants have recognised in this regard that a large part of the memory bandwidth that is consumed when performing tile-based graphics processing relates to the need to store (intermediate) geometry data that has been generated by the geometry processing to memory between the geometry processing and the rendering/fragment processing.

The technology described herein, by allowing (some of the) geometry processing to be deferred until the rendering stage, can remove the need to store the result of that geometry processing in memory from the geometry processing prior to binning for later use by the rendering stage (which would be the case where all the geometry processing is performed prior to binning).

Thus the operation in the manner of the technology described herein facilitates reducing the memory bandwidth that is required for the overall graphics processing pipeline execution, for example, by, in effect, generating data from geometry processing at a later stage in the graphics processing pipeline (and correspondingly “closer” to the point where that data will be used). This can also accordingly facilitate storing that geometry processing data “locally” to the graphics processing stage where it is required/used, without the need, for example, for it to be stored in a longer term fashion, for example in (main) memory for later use.

Furthermore, at least some of the geometry processing that is performed in a deferred manner (at the rendering stage) can be, and is in an embodiment, omitted from the initial geometry processing operation (prior to the binning stage). This will then allow the amount of geometry processing that is initially performed to be reduced. Furthermore, that geometry processing for geometry that in fact is not required for any rendering tiles can be omitted completely.

The Applicants have further recognised that when later performing geometry processing that has been deferred to the rendering stage, it may be desirable to (try to) ensure that any data that is generated when performing the geometry processing that is deferred can be retained locally to the graphics processor without, for example, needing to be stored in main memory, so as to thereby reduce any memory bandwidth, for example, that will be consumed by the deferred geometry processing.

In the technology described herein, in order to (try to) ensure that any data that is required or generated when performing geometry processing that has been deferred can be retained locally to the graphics processor whilst performing the deferred geometry processing, an amount of geometry processing to be performed at the rendering stage is tracked for respective regions of a render output being generated, and when the amount of geometry processing to be performed at the rendering stage for a region reaches a threshold, rendering of the region is triggered.

As will be discussed in more detail below, this then (in an embodiment) has the effect of causing any geometry processing that has been deferred for the region for the render output up to that point to be performed, thereby, in effect, limiting (capping) the amount of data that needs to be stored when performing the (deferred) geometry processing at the rendering stage. For example, by setting the threshold that triggers rendering of the region appropriately, it can (in principle) be ensured that the amount of deferred geometry processing that is needed to be done when the rendering of the region is triggered is such that any data that is required or generated when performing the deferred geometry processing can be retained locally to the graphics processor.

Furthermore, once the rendering for a region has been performed (thereby consuming (performing) any existing deferred geometry processing for the region), if there is any further geometry to be processed for the region that geometry can be processed, with geometry processing (again) being permitted to be deferred until the rendering stage for the region.

The effect of this then can be, and is in an embodiment, that geometry processing for a region of a render output will be performed up until a threshold amount of geometry processing is to be performed at (has been deferred to) the rendering stage for the region, at which point rendering of the geometry for the region to date (at that point) will be triggered, thereby performing any currently deferred geometry processing for the region. If any geometry remains to be processed for the region, then that can be continued with, with a new set of geometry processing being deferred until the rendering stage (up until the threshold is reached, at which point rendering will be triggered again), and so on (in dependence, for example, upon how much geometry is present in the region).

This can then allow for greater amounts of geometry processing to be deferred for a render output, whilst still avoiding data generated when performing geometry processing that has been deferred being needing to be stored out to main memory, as compared to other arrangements, such as, for example, simply imposing a cap on the maximum amount of geometry processing that can be deferred for a render output (or for respective regions of a render output).

Furthermore, considering the amount of geometry processing to be performed at (that has been deferred to) the rendering stage (and triggering “early” rendering) on a region by region basis, reduces the amount of rendering that may need to be triggered “early” in this manner for the render output as a whole, as that will have the effect of causing rendering to be triggered during the geometry processing only for regions where more geometry is present (such that more geometry processing is (likely to be) deferred), whereas for regions where less geometry is present (where less geometry processing is (likely to be) deferred), the geometry processing “threshold” may not be reached before all the geometry for the output in question has been (initially) processed.

The Applicants have recognised in this regard that the distribution of geometry in a render output may, and typically will, be uneven across the render output, such that for some regions there may be more geometry to be processed than for other regions. The technology described herein will have the effect of triggering rendering whilst the geometry processing is going on for more “complex” regions where there is a greater amount (concentration) of geometry, but not for less “complex”regions where there is less geometry.

The effect of this then is that such “early” (“incremental”) rendering may be triggered for only certain regions of the render output (and only when necessary for a region) rather than, for example, simply having to trigger (incremental) rendering for all of a render output once a threshold amount of (deferred) geometry processing has been reached. This should then reduce the overall amount of rendering that is triggered and performed “early” during the geometry processing, and correspondingly reduce any overhead associated with performing such “early” (incremental) rendering (as compared, for example, to triggering such “early” (incremental) rendering for the entire render output once a threshold amount of geometry processing has been deferred).

The Applicants have recognised in this regard that there can be significant overhead associated with performing such “early” (incremental) rendering before all the geometry has been (initially) processed for a render output. The technology described herein can reduce the amount of such overhead that is incurred, whilst still facilitating deferring geometry processing, e.g. as much as possible.

The technology described herein will also have the effect of overlapping (interleaving) geometry processing and rendering (causing the geometry processing and rendering to be performed at least to some extent in parallel), in particular for more geometry complex regions of a render output, such that when the geometry processing is finished for a render output, there should be relatively little rendering left to be performed (even for more geometry complex regions of the render output) (as compared to the case where all of the (initial) geometry processing is completed before beginning any rendering). Correspondingly, when all of the geometry processing for a render output is completed, there should not be any “complex” regions of the render output completely outstanding (which could take longer to render), as such “complex” regions of the render output will have already been partly rendered.

This can then reduce latency, e.g. in terms of how quickly a render output can be completed (and, e.g. ready for display). This may be particularly beneficial, for example, for virtual reality or augmented reality applications.

The geometry processing that is and can be performed in the technology described herein can comprise any suitable and desired sequence of one or more geometry processing stages that may be performed as part of a graphics processing pipeline.

In an embodiment, the geometry processing comprises one or more of, and in an embodiment plural of, the following geometry processing stages: a position shader (position shading); a vertex shader (vertex shading); a tessellation control shader (tessellation control shading); a task shader (task shading); a tessellation shader (tessellation shading); a mesh shader (mesh shading); a tessellation evaluation shader (tessellation evaluation shading); a geometry shader (geometry shading); and a transform feedback shader (transform feedback shading). The geometry processing may comprise one or more of these shader stages, as desired.

The sequence of one or more geometry processing stages is in an embodiment implemented and executed as a geometry processing pipeline, comprising the sequence of one or more geometry processing stages in question.

The geometry processing may, in effect, operate on, and process, individual geometry elements, such as, and in an embodiment, (individual) primitives (and in one embodiment, that is the case). In this case geometry processing may be, and is in an embodiment, deferred for respective individual geometry elements (e.g. primitives), e.g. on a primitive-by-primitive basis.

In an embodiment the geometry processing, in effect, operates on, and processes, respective groups of geometry elements (such as, and in an embodiment, respective groups of primitives). In this case geometry processing may be, and is in an embodiment, deferred for respective groups of geometry elements (e.g. primitives), e.g. on a group of primitives-by-group of primitives basis.

In an embodiment the geometry processing generates (and processes) respective (geometry) packets that each store data for geometry to be processed (for the render output in question). In this case geometry processing may be, and is in an embodiment, deferred for respective individual (geometry) packets, e.g. on a (geometry) packet-by-(geometry) packet basis.

In an embodiment a (and each) (geometry) packet that the geometry processing generates stores data for a set of one or more primitives (and in an embodiment for a set of plural primitives) to be processed (for the render output in question).

Each (geometry) packet may store any suitable and desired data for the geometry (e.g. set of one or more primitives) that it relates to. For example, a (geometry) packet may, and in an embodiment does, store appropriate attributes, such as positions and varyings, for a set of (in an embodiment plural) vertices for the geometry (e.g. set of primitives) that the packet relates to, for example, and in an embodiment, together with a set of identifiers (indices) for the vertices that can be used to determine how the vertices are used for the geometry (e.g. primitives) that the packet relates to. A packet may also store attributes and identifiers for the geometry, e.g. primitives, itself, if desired, and/or other, e.g., state, information relating to the geometry that the packet relates to.

Other arrangements would, of course, be possible.

The initial (geometry) packets that are generated by the geometry processing may be created in any suitable and desired manner. For example geometry and/or work items (e.g. vertices) relating to that geometry may be progressively added to a packet, e.g. until a condition for finishing the packet (and, if necessary, starting a new packet), such as a maximum amount of geometry and/or work items for the packet being met, is reached.

In an embodiment, each respective geometry processing stage of the sequence of one or more geometry processing stages for the geometry processing (pipeline) that is being executed, generates a respective geometry packet(s), and provides that respective geometry packet as an input packet to a next geometry processing stage of the sequence (if any), with that next geometry processing stage of the sequence then processing the input packets that it receives to generate one or more output geometry packets, that are then provided as inputs to a next geometry processing stage of the sequence (if any), and so on.

Thus, in an embodiment, the first stage of the geometry processing, which in an embodiment comprises position shading or vertex shading (comprising both position shading and varying shading, for example), acts as an “input packetizer” that generates initial packets storing data for geometry to be processed. These initial geometry packets are then in an embodiment appropriately processed by (any) subsequent stages of the geometry processing to generate, for example, modified versions of the initial geometry packets and/or to generate additional geometry packets, as required. For example, a mesh shader may generate multiple packets from a single input (e.g. task shader) packet.

In the technology described herein geometry processing can be deferred until the rendering stage for geometry being processed.

In an embodiment, the possibility of deferring geometry processing can be selectively enabled, in an embodiment on a render output by render output (e.g. draw call) basis. Thus, for example, and in an embodiment, the possibility of deferring geometry processing is able to be set globally for a given render output (e.g. draw call), such that where deferred geometry processing is not enabled (is determined to not be performed) for a render output, all the geometry processing for the render output will be performed as part of the geometry processing prior to the binning stage. On the other hand, where deferred geometry processing is enabled for a render output, then it will be permitted for at least some of the geometry processing for the render output to be deferred to the rendering stage.

Where geometry processing is deferred for a render output, geometry processing may be deferred for respective individual geometry elements, such as primitives, and on that individual geometry element by geometry element basis (on a primitive by primitive basis) (and in one embodiment that is what is done), or the geometry processing may be deferred in respect of groups of plural geometry elements (e.g. groups of primitives) and deferred correspondingly on a geometry element group by geometry element group basis (and in another embodiment, that is what is done).

In an embodiment, the geometry processing is deferred for and in respect of, individual (respective) geometry packets (as discussed above), and so is performed on a geometry packet by geometry packet basis.

It would be possible simply to defer (some) geometry processing for all geometry (e.g. all primitives and/or all geometry packets) that are being processed for a render output (where enabled) (and in one embodiment that is what is done).

In an embodiment, geometry processing can be selectively deferred for (respective) geometry being processed (where enabled for a render output), for example, and in an embodiment, for respective primitives (on a primitive by primitive basis) and/or for respective geometry packets (on a geometry packet by geometry

### Packet Basis) (as Appropriate).

Thus, in an embodiment, the method of the technology described herein comprises (and the graphics processor comprises a processing circuit or circuits configured to):
determining whether some geometry processing for geometry to be processed for a render output, and in an embodiment for a packet storing data for geometry to be processed for a render output, should be deferred until the rendering stage of (until after a binning stage of) the graphics processing pipeline being executed; and
when it is determined that some of the geometry processing should be deferred until the rendering stage of (until after the binning stage of) the graphics processing pipeline being executed, determining to defer some of the geometry processing until the rendering stage of (until after the binning stage of) the graphics processing pipeline being executed;
and
when it is determined that the geometry processing should not be deferred, performing all of the geometry processing for the geometry (packet) prior to the binning stage.

In these embodiments, the decision as to whether to defer geometry processing for geometry (e.g. a packet) can be based on any suitable and desired criteria. In an embodiment, there are one or more, and in an embodiment plural, conditions that must be met for geometry processing for geometry (e.g. a packet) to be deferred.

In an embodiment, the decision takes account of, and is based on, whether the geometry processing that is (potentially) to be deferred will result in less (intermediate) data from that geometry processing needing to be stored until the rendering stage, as compared to the amount of (intermediate) data that would need to be stored until the rendering stage in the case that the geometry processing is deferred. For example, a mesh shader may generate plural output packets from a single input packet, and so it may be preferable to defer mesh shading where possible and appropriate, so as to reduce the amount of (intermediate) data that has to be stored.

In an embodiment, geometry processing for geometry (e.g. a packet) is not deferred (is other than deferred) when a bounding box for the geometry (e.g. packet) (the footprint of the bounding box for the geometry, e.g. packet, in screen space) is larger than a particular, in an embodiment selected, in an embodiment predetermined, threshold size.

The threshold size that the bounding box for geometry, e.g. a packet, must be smaller than for geometry processing to (potentially) be deferred may be any suitable and desired size, and may be represented and considered in any suitable and desired manner. In an embodiment, the threshold bounding box size (area) is defined as, and comprises, a set of x*y rendering tiles. Thus, for example, the threshold size could be set such that the geometry processing for geometry, e.g. a packet, will not be deferred if the bounding box for the geometry, e.g. packet, is not fully within a single rendering tile, or a 2×1 group of rendering tiles, or a 2×2 group of rendering tiles, etc., as desired.

Constraining the (screen-space) size of geometry (e.g. packets) for which geometry processing can (potentially) be deferred to the rendering stage can, for example, reduce the likelihood of having to perform any deferred geometry processing multiple times at the rendering stage (for example where geometry falls to be processed for plural rendering tiles).

In an embodiment, when (if) geometry, e.g. a packet, (its bounding box) extends into more than one region that a render output is divided into for deferred geometry tracking purposes (crosses such “tracking” region boundaries), then the geometry processing for the geometry, e.g. a packet, is not deferred, but rather all the geometry processing for the geometry, e.g. packet, is performed prior to the binning stage. This will then avoid having to perform “deferred” geometry processing for given geometry, e.g. a packet, for multiple regions at the rendering stage.

Thus, in an embodiment, geometry processing for a packet is only deferred when the geometry (e.g. a packet) is wholly contained within a single “racking” region of the render output.

Other arrangements and considerations would, of course, be possible.

It will be appreciated from the above, that in embodiments of the technology described herein at least, the decision as to whether or not to defer geometry shading for geometry, e.g. a packet, to the rendering stage will use and be based on a bounding box for the geometry, e.g. packet, in its form at which the decision as to whether to defer geometry processing or not is being made.

The bounding box for geometry, e.g. a packet, for this purpose can be determined in any suitable and desired manner. Embodiments for determining a bounding box for geometry, e.g. a packet, for this purpose (and other purposes) will be discussed in more detail below.

The geometry processing that is (potentially) deferred to the rendering stage (from the geometry processing prior to the binning stage) may be any suitable and desired geometry processing (geometry processing stage) that is to be performed as part of the overall geometry processing sequence (pipeline) for the graphics processing pipeline being executed. In an embodiment, it comprises the last (final) geometry processing stage of the sequence of geometry processing stage(s) that are to be performed for the graphics processing pipeline being executed.

Thus in an embodiment, the geometry processing that is (potentially) deferred to the rendering stage comprises one or more, and in an embodiment the last one, of the geometry processing stages of the sequence of one or more geometry processing stages that are to be performed for the graphics processing pipeline being executed.

Thus, in the case where the sequence of one or more geometry processing stages for the graphics processing pipeline being executed comprises N geometry processing stages (where N is an integer greater than zero), the method of the technology described herein in an embodiment comprises (and the graphics processor is correspondingly in an embodiment configured to) determining whether to defer the Nth geometry processing stage until the rendering stage, and when it is determined to defer the Nth geometry processing stage until the rendering stage, performing N−1 of the geometry processing stages of the sequence of N geometry processing stages of the graphics processing pipeline being executed prior to the binning stage.

In an embodiment, the geometry processing that is (potentially) deferred to the rendering stage comprises one of: a vertex shader (vertex shading); a mesh shader (mesh shading); a tessellation evaluation shader (tessellation evaluation shading); a geometry shader (geometry shading); or a transform feedback shader (transform feedback shading).

At least in the case where geometry processing is (potentially) deferred on a primitive by primitive basis (for respective individual graphics primitives), the geometry processing that is (potentially) to the deferred rendering stage in an embodiment comprises a vertex shader (vertex shading), and, in an embodiment (at least) vertex varying shading.

The geometry processing that is (potentially) deferred from the initial geometry processing could comprise only some but not all of the relevant geometry processing (stage), but in an embodiment, all of the relevant processing for the geometry processing (stage) in question is deferred to the rendering stage.

Correspondingly, in an embodiment, at least some of the geometry processing that is determined to be deferred to the rendering stage is not performed (is other than performed) as part of the geometry processing prior to the binning stage (is omitted from the geometry processing for the geometry prior to the binning stage).

Thus, in the case where it is determined to defer some of the geometry processing until after the binning stage, then in an embodiment at least some of the geometry processing that is being deferred is not performed (is omitted) prior to the binning stage.

It would be possible in this regard for only some but not all of the relevant (deferred) geometry processing for the geometry processing (stage) to be omitted (not performed) prior to the binning stage, but in an embodiment none of the geometry processing that will be deferred to the rendering stage is performed as part of the geometry processing prior to the binning stage (all of the geometry processing for the geometry processing (stage) in question is deferred to the rendering stage).

When geometry processing for geometry (e.g. a primitive or geometry packet) is deferred, an indication is in an embodiment provided and, e.g., and in an embodiment, associated with the geometry, so it can be determined that the geometry has had (some of) its geometry processing deferred (so that such “deferred” geometry can then be identified at the rendering stage). This can be indicated in any suitable and desired way, but is in an embodiment done by associating some form of indicator that can be used to indicate that geometry processing has been deferred with the geometry in question.

Thus, in the case where the geometry processing produces geometry packets and geometry processing can be (potentially) deferred for geometry packets, in an embodiment when geometry processing for a packet is deferred, the packet is indicated as having had (some of) its geometry processing deferred (so that such a “deferred” packet can then be identified at the rendering stage). This indication can take any suitable and desired form, but is in an embodiment in the form of an indicator that can be used to indicate that geometry processing for the packet has been deferred (and so needs to be performed, where appropriate, at the rendering stage).

In an embodiment, the “deferred” indication is associated with (and stored with) the geometry, e.g. packet, in its entry or entries in the appropriate binning data structure or structures that the binning stage generates. Thus, for example, and in an embodiment, where the binning stage generates (hierarchies of) bounding boxes, for geometry, e.g. a packet, for which geometry processing has been deferred, the binning data structure will store a bounding box for the, e.g. packet, and an indicator (e.g. flag) indicating that geometry processing for the, e.g. packet, has been deferred.

In the case where geometry processing for geometry, e.g. a packet, is deferred, then in an embodiment, any information and data necessary for the later performance of the geometry processing (for performing the deferred geometry processing (stage)) is stored appropriately, so as to allow the deferred geometry processing to be performed later, at the rendering stage.

This data can be any suitable and desired data that will be needed for performing the geometry processing at the rendering stage.

It may for example, and in an embodiment does, comprise any data, such as state data, that is required for performing the geometry processing in question.

Any state (e.g. shader configuration) information that is needed for performing the later geometry processing is in an embodiment stored in the binning data structures that are generated by the binning stage, for example, and in an embodiment, in association with appropriate entries for the, e.g. packet in question, in those binning data structures.

In the case of a geometry packet, in an embodiment any input packet or packets required for performing the deferred geometry processing for the packet are stored for later use.

The input packets for the geometry processing that is deferred are in an embodiment stored appropriately in memory so that they can be retrieved when the geometry processing is performed at the rendering stage. In an embodiment, the storing of input packets in this manner and for this purpose is tracked, so that duplicated storing of input packets can (try to) be avoided.

The determination of whether to defer geometry processing for geometry, e.g. a packet being processed by the geometry processing pipeline (when enabled for a render output), may be performed by any suitable and desired element and component of the graphics processor and of the graphics processing pipeline that is being executed.

This decision and determination could be made by the appropriate geometry processing pipeline stage, e.g. before the last geometry processing stage in the geometry processing pipeline being executed is started.

In an embodiment, the binning stage of the graphics processing pipeline determines whether or not to defer geometry shading for geometry, e.g. a packet. In an embodiment this decision is performed by the binning stage before the binning stage includes the geometry, e.g. packet, in (processes the geometry, e.g. packet, in respect of) the binning data structures that the binning stage generates.

Thus, in an embodiment, when the last stage of the geometry processing pipeline being executed is reached (and before that geometry processing stage is performed), that is signalled to the binning stage, for the binning stage to then determine whether that final geometry processing stage should be deferred or not.

(The final stage of a geometry processing pipeline that is being executed is in an embodiment indicated as such, such that reaching that final stage for geometry, e.g. a packet, can be identified and correspondingly signalled to the binning stage for this determination to take place.)

When it is determined that the geometry processing for geometry, e.g. a packet, should not be deferred, then the binning stage is in an embodiment operable to, and operates to, trigger the performance of the final geometry processing stage at that point. In this case therefore the geometry, e.g. packet, will be subjected to the final geometry processing stage, and then that “completely” processed geometry, e.g. geometry packet, will be, and is in an embodiment, returned to the binning stage for the binning stage to process that geometry, e.g. packet, accordingly.

On the other hand, when the binning stage determines that the final geometry processing stage should be deferred for geometry, e.g. a packet, then the binning stage in an embodiment does not trigger (other than triggers) the performance of the final geometry processing stage at that point, and instead, in an embodiment, then processes the geometry, e.g. packet, in its current form (i.e. as it is prior to the geometry processing that is to be deferred), to include the geometry, e.g. packet in a binning data structure or structures accordingly.

In this case therefore a geometry packet (for example) that will be subjected to the binning process will be a packet for which the geometry processing has not been completed. This being the case, the binning stage in an embodiment processes that “incompletely geometry processed” packet so as to be able to include the packet in a binning data structure or structures accordingly, but does not perform any further processing for the packet that it would normally perform when processing a “completely geometry processed” packet.

Thus, in embodiments at least, the binning stage will receive from the geometry processing either a “completely” geometry processed packet for processing, or a packet for which the geometry processing has not been completed (for example, and in an embodiment, a packet for which all but the final geometry processing stage has been completed).

The binning stage should, and in an embodiment does, process the geometry, e.g. packets, it receives for processing (whether “completely” geometry processed or not) to generate one or more data structures that can be used to determine whether (the respective) geometry, e.g. packets, should be processed for respective rendering tiles. Thus, the binning stage in an embodiment generates one or more data structures that can be used to determine whether geometry to be processed, e.g., and in an embodiment, packets storing data for geometry to be processed, should be processed for a rendering tile.

The “binning” data structures that are generated by the binning stage for this purpose can take any suitable and desired form. For example, they could comprise lists of geometry (e.g. primitives or geometry packets) to be processed for respective rendering tiles or sets of plural rendering tiles (which geometry, e.g. packet, “tile” lists can then be used to determine which geometry, e.g. primitives or packets, apply to a given tile).

In an embodiment, the (binning) data structures that can be used to determine whether geometry to be processed should be processed for a rendering tile comprise, in an embodiment hierarchies of, bounding boxes that can be used for that purpose.

Thus, in the case where the geometry processing generates and processes geometry packets storing data for a set of one or more primitives to be processed, in an embodiment, the (binning) data structures that can be used to determine whether packets storing data for a set of one or more primitives to be processed should be processed for a rendering tile comprise, in an embodiment hierarchies of, bounding boxes that can be used for that purpose. In an embodiment this comprises both bounding boxes for respective individual packets, together with bounding boxes for respective groups of plural packets (and, if desired, for respective groups of groups of plural packets, and so on, if desired).

In this case to determine geometry, e.g. packets, that should be processed for a rendering tile, the rendering tile can be, and will be, and in an embodiment is, compared against the respective bounding boxes to identify the geometry, e.g. those packets, that apply to the tile.

The binning stage can generate the data structures to be used to determine which geometry, e.g. packets, should be processed for a rendering tile in any suitable and desired manner. In an embodiment it uses an appropriate bounding box for geometry, e.g. a packet, for this purpose.

For example, in the case where the binning stage prepares lists of primitives or packets to be processed for tiles, a bounding box for a primitive or packet can be compared to the tiles' positions to identify which tile(s) the primitive or packet applies to.

In the case where the binning data structure(s) comprises bounding boxes for geometry, e.g. packets, the bounding box for geometry, e.g. a packet, can be included in those data structures appropriately.

The bounding box for geometry, e.g. a packet, for this purpose (and for other purposes, e.g. to determine whether to defer geometry processing for geometry, e.g. a packet, as discussed above), can be determined in any suitable and desired manner.

For example, in the case where geometry processing for geometry, e.g. a packet, is not deferred (such that the geometry processing for the geometry, e.g. packet, will be completed prior to the binning stage), the binning stage in an embodiment derives a bounding box for the “completed” geometry, e.g. packet, to then use for processing the geometry, e.g. packet, for, and including the geometry, e.g. packet, in, the binning data structure or structures that the binning stage is generating.

In the case where the necessary information for determining a bounding box for the geometry, e.g. packet, in its “current” form is available from the geometry processing that has been performed, then that information from the geometry processing that has been performed can be, and is in an embodiment, used to determine a bounding box for the geometry, e.g. packet, in question.

Thus, in the case where a (the final) geometry processing stage is to be deferred for a packet, but the necessary information for determining a bounding box for the packet in its “current” form is available from the geometry processing that has been performed, then that information from the geometry processing that has been performed again can be, and is in an embodiment, used to determine a bounding box for the packet in question.

Alternatively, any necessary geometry processing, such as position/vertex shading, that is required to provide appropriately processed (transformed) vertex positions for vertices for primitives in the packet to allow a bounding box for the packet to be determined could be performed (and in one embodiment, that is the case). Thus, in this case, when the (final) stage of geometry processing is to be deferred for a packet, in an embodiment some geometry processing, such as position shading of vertices for primitives of the packet, is still performed, to allow a bounding box for the packet to be determined (but the complete geometry processing for the final stage of the geometry processing that is to be deferred will not be performed).

In an embodiment, the bounding box for a (deferred) packet is determined without (with other than) needing to perform (and performing) any position shading for vertices for primitives in the packet (where that information is not already available from the geometry processing that has been performed).

In one such embodiment, the bounding box is derived using information, e.g., and in an embodiment, from the application for which the graphics processing is being performed (application supplied information), for example, and in an embodiment, that defines a bounding volume for the packet and a way to transform the bounding volume to derive a bounding box for the packet. In this case therefore, there will be appropriate (meta)data associated with the packet, in an embodiment provided by the application, e.g. that defines a bounding volume for the packet and the way to transform the bounding volume to determine a bounding box for the packet. The binning stage will then use this information to determine a bounding box for the packet in question.

In an embodiment, the binning stage can also or instead, in an embodiment also, determine the bounding box for a packet from information that has been generated by a geometry processing stage or stage that has already been executed for the packet (and that precedes the geometry processing stage that is being deferred). This information can comprise any suitable and desired information that can allow a bounding box for a packet to be determined.

For example, in the case of a tessellation shader, the tessellation output may consist of barycentric coordinates (which will be expanded to vertices and primitives in a tessellation evaluation shader). In this case, the tessellation shader may be configured to provide the bounding volume in barycentric coordinates, with the tessellation evaluation shader being configured to transform those coordinates into screen space bounding box coordinates (which will then provide a bounding box for the packet in question).

Other arrangements would, of course, be possible.

In the case where geometry processing for a packet is not deferred, then in an embodiment the binning stage operates to process the (finished) (geometry) packet output by the (complete) geometry processing, to generate a processed (primitive) packet therefrom (which is then the packet that is included in the appropriate data structure that can be used to determine whether packets should be processed for a rendering tile (and that is then processed by the rendering stage)).

The processing that the binning stage performs on a geometry packet in this regard can comprise any suitable and desired processing, but in an embodiment comprises at least performing appropriate culling operations for the primitives in the geometry packet, e.g., and in an embodiment to, (try to) cull primitives based on the view frustum and/or the facing direction of the primitives.

The processing in an embodiment also comprises determining bounding boxes for the individual primitives in the (primitive) packet, and using those individual primitive bounding boxes to derive a bounding box for the (processed) primitive packet that the binning stage is generating, and to generate one or more binning data structures that can be used to determine whether the primitives should be processed for a rendering tile.

With regard to the latter processing, this may comprise generating appropriate lists of primitives to be processed for a rendering tile or sets of plural rendering tiles based on the primitive bounding boxes, and/or including the primitive bounding boxes in the bounding box based binning data structures that the binning stage generates, as appropriate.

(Thus the packets storing data for geometry (e.g. for sets of primitives) that the binning stage generates binning data structures for (and including) may be (geometry) packets containing data for geometry to be processed generated by (some but not all of) the complete geometry processing pipeline, and/or there may be (primitive) packets that have been generated from “completely processed” geometry packets generated by the (complete) geometry processing pipeline by the binning stage.)

Correspondingly, in the case where geometry processing can be and is deferred for respective individual primitives (on a primitive by primitive basis), then in the case where geometry processing for a primitive is not deferred, in an embodiment the binning stage operates to perform any desired further processing on the (finished) primitive following the (complete) geometry processing, such as, and in an embodiment, at least performing appropriate culling operations for the primitive, e.g., and in an embodiment, to (try to) cull the primitive based on the view frustum and/or the facing direction of the primitive.

The processing in an embodiment also comprises determining a bounding box for the primitive (if not already available/provided), and using that bounding box when generating a binning data structure or structures that can be used to determine whether the primitive should be processed for a rendering tile (for example to determine whether to include the primitive in list(s) of primitives to be processed for rendering tiles).

In the technology described herein, an amount of geometry processing to be performed at the rendering stage is tracked for respective regions of a plurality of regions that the render output has been divided into (for tracking purposes).

The sub division of a render output into regions for this purpose can be made in any suitable and desired manner.

In an embodiment, a render output is divided into a plurality of equally sized (equal area), and in an embodiment the same shape (configuration), regions.

Each region in an embodiment corresponds to an integer number of (complete) (and in an embodiment contiguous) rendering tiles. For example, a render output could be divided into regions each corresponding to a single rendering tile, or into a plurality of regions each corresponding to a set of plural rendering tiles, such as 2×2 rendering tiles.

It would also be possible for the regions that the render output is divided into to have different sizes and/or shapes if desired. For example, some regions could be larger than other regions (e.g. depending upon their position in the render output and/or some analysis of the likely content of different parts of a render output).

The sub division into tracking regions could be the same for each and every render output. Alternatively, the region sub division, e.g. the size and shape of the, and/or the number of, regions could be settable and set in use, for example on a render output by render output basis. For example, a driver for the graphics processor could set the number of regions and/or region configuration (e.g. size and shape) for respective render outputs or sets of render outputs, for example based on a consideration of the anticipated geometry content of the render output(s).

In an embodiment, the sub division into regions for deferred geometry tracking purposes is based on and takes account of the tracking overhead that will be required for tracking an amount of geometry processing for the regions. In this regard, the Applicants have recognised that the greater number of regions that a render output is divided into for tracking purposes, the greater the overhead for performing the tracking will be (e.g. in terms of the number of tracking records that need to be maintained and updated). Thus, the greater the number of regions, the greater the tracking overhead, and vice versa.

In an embodiment, the graphics processor is configured and operable to support tracking of (to track) (up to) a particular (maximum) number of regions. In this case, the graphics processor could, and in one embodiment is, simply configured to always track that particular (maximum) number of regions for each and every render output.

In an embodiment, the number of regions that are tracked for a render output is selectable and set in use (up to a particular (maximum) number of regions for which tracking is supported). In this case, the number of regions that are tracked (up to the maximum) may, for example, and in an embodiment, take account of the size of the regions that will be being tracked.

In the case where the number of regions that is tracked for a render output is set (whether always to a fixed maximum number of regions or to a variable number of regions that is set in use), then a (and any) render output will correspondingly be divided into that number of regions for tracking purposes (and in an embodiment into that number of same sized and shaped regions).

In an embodiment, the sub division of a render output into regions for tracking purposes is also or instead (and in an embodiment also) based on the size of the regions that will be being tracked.

The Applicants have recognised in this regard that the larger the size of the regions (e.g. in terms of a number of rendering tiles that they encompass), then the greater the overhead when rendering a region, and, for example, the more likely that the amount of geometry processing for the region will exceed the threshold amount to trigger (early) rendering of the region. Thus, smaller sized regions may be preferable, as the overhead of performing “early” rendering for such regions and the likelihood of triggering “early” rendering for such regions in the manner of the technology described herein may then be reduced.

Thus, in an embodiment, a render output is in an embodiment (and preferentially) divided into smaller regions for tracking purposes where possible (and e.g., and in an embodiment, subject to the available region tracking capacity of the graphics processor). For example, and in an embodiment, a preferred region size could be set, and a given render output divided into regions of that size for geometry tracking purposes whenever the resulting number of regions for a render output can be supported by the region tracking capacity of the graphics processor, but with larger region sizes being used in the case where the region tracking capacity of the graphics processor is insufficient to track the number of regions that would be required when using the smaller region size.

It would be possible, for example, to keep all counters in memory, e.g. with a small cache to avoid excessive memory bandwidth. In an embodiment a fixed number of counters is selected based on the sub-division desired for different resolutions. For example, 150 counters should give, e.g., 4×4 tile regions in 4k resolution, 3×2 tile regions in 2k resolution, etc..

Other arrangements would, of course, be possible.

In the technology described herein when the (tracked) amount of geometry processing to be performed at the rendering stage for a “tracking” region reaches a permitted threshold value, rendering of geometry for the region is triggered.

The threshold amount of geometry processing that triggers the rendering of geometry for a region can be set to any suitable and desired threshold value. For example, it could (and in one embodiment does) simply comprise a threshold number of geometry elements (e.g. packets) for the region (with once that threshold number of geometry elements (e.g. packets) being reached for a region, rendering for the region then being triggered).

In an embodiment, the same threshold for triggering the rendering of geometry for a region is used for each region of a given render output. In one embodiment, the graphics processor is configured to simply use the same threshold for any and all regions that are being tracked for this purpose (and for any and all render outputs). However, it would, if desired, be possible to allow the threshold for triggering the rendering of geometry for a region and/or render output to be settable in use, if desired, for example for respective regions within a render output and/or on a render output by render output basis.

In an embodiment, the threshold of geometry processing that triggers the rendering of geometry for a region takes account of (is based on) an amount of data that would be generated and accordingly need to be stored at the rendering stage when performing geometry processing for a region (at the rendering stage).

The Applicants have recognised in this regard that when performing (deferred) geometry processing at the rendering stage, it would be desirable (and advantageous) to be able to store, if at all possible, all of the (temporary) data that is generated by that (deferred) geometry processing locally on the graphics processor while the rendering is being performed, so as to avoid the need to store such data in main memory, for example.

By setting the threshold for triggering “early” rendering in the manner of the technology described herein based on and considering the amount of data that can be stored locally for the deferred geometry processing (for the geometry processing at the rendering stage), it can be more reliably ensured that any data generated by the deferred geometry processing will be able to be stored locally (on-chip) at the rendering stage and not need to be “spilled” to main memory, for example.

Thus, in an embodiment, the threshold amount of geometry processing that triggers the rendering of geometry for a region in the manner of the technology described herein is based on, and takes account of, a permitted, e.g. predetermined, storage capacity for storing data that will be generated by the (deferred) geometry processing locally on the graphics processor (and is in an embodiment set such that the amount of geometry processing represented by the threshold should mean that (will be expected to result in) all of the (temporary) data that is generated while performing the (deferred) geometry processing can be (being able to be) stored in that local storage of the graphics processor).

In an embodiment, a particular amount of local storage is set aside for this purpose, and the threshold amount of geometry processing for triggering the rendering of geometry for a region is set based on, and takes account of, that allocated local storage capacity.

Thus, in an embodiment of the technology described herein, the graphics processor includes local storage (on-chip storage) for storing data that is generated when performing geometry processing at the rendering stage (with data that is generated when performing geometry processing at the rendering stage correspondingly being (preferentially) stored in that local storage (rather than main memory, for example)).

It would be possible for there always to be a fixed amount of local storage capacity set aside for this purpose (and in one embodiment that is what is done). Alternatively, the permitted local storage capacity could be settable and set in use, for example on a render output by render output basis. In this case, the permitted local storage capacity may first be set, with the thresholds for the regions then being set accordingly. This may be done, for example, under the control of a driver for the graphics processor.

The local storage of the graphics processor in this regard could be storage that is dedicated for this purpose, such as dedicated on-chip storage, and which storage does not have any access to main memory, for example, such that there would then be no risk that data stored in the dedicated local storage could be evicted to main memory, for example.

In an embodiment, the local storage is part of the cache hierarchy of a memory system of or accessible to the graphics processor, and in an embodiment an L2 cache of that cache hierarchy. In an embodiment an appropriate amount of cache hierarchy (e.g. L2 cache) storage is allocated and reserved for this purpose (this data). Using a cache hierarchy of the memory system has the advantage that there should then be no hard limit on the data that can be stored, e.g. in the case of an “out of memory” situation arising.

This said, the Applicants have recognised that it would still be desirable in any event to try to avoid any likelihood of temporary data generated in this regard “spilling out” to main memory, for example (being evicted from a cache to main memory). Accordingly, in an embodiment any such data that is stored locally, e.g. in the L2 cache, is in an embodiment invalidated in the cache once it is no longer needed, so as to reduce or avoid the likelihood of that data being evicted from the cache, e.g. to main memory.

In an embodiment, the local storage can be and is in an embodiment reused for successive render output regions that are being rendered. In this case, the storage (the stored geometry data) is in an embodiment deallocated and invalidated once a region has been processed (and before reuse), so as to, for example, avoid the (temporary) data being evicted to main memory.

Thus, in an embodiment, the method of the technology described herein comprises (and the graphics processor is correspondingly configured to):
when performing (deferred) geometry processing for a region of the render output at the rendering stage, allocating storage capacity of local storage for storing the results of that geometry processing, storing the results of the geometry processing for the region in the allocated local storage capacity, and deallocating (and in an embodiment invalidating) the allocated local storage capacity once the rendering of the region has been completed.

(Correspondingly, there is in an embodiment a different, separate memory region(s) allocated for storing the results of (non-deferred) geometry processing performed prior to the binning stage, which is (only) deallocated once all the rendering for the render output in question has been completed (once all the regions that the render output has been divided into have been (completely) rendered).)

It will be appreciated from the above, that in an embodiment, the threshold for triggering rendering for a region accordingly represents, and in an embodiment corresponds to (is based on), a threshold amount of data capacity that is permitted for the performing of (deferred) geometry processing when rendering the region.

Thus, in an embodiment, the method of the technology described herein comprises (and the graphics processor is correspondingly configured to) tracking whether the amount geometry processing to be performed at the rendering stage for a region will cause (risk causing) a threshold data capacity set for the storing of data for geometry processing for the region at the rendering stage to be exceeded, and when it is determined that the amount of geometry processing to be performed at the rendering stage for the region will exceed (risk exceeding) the data storage capacity threshold, triggering rendering of the region.

The amount of geometry processing to be performed at the rendering stage for a region (and the corresponding comparison to a threshold amount of geometry processing) may be assessed and considered (tracked) in any suitable and desired manner, and using any suitable and desired measure of the amount of geometry processing to be performed at the rendering stage.

In an embodiment, as discussed above, this is assessed and tracked in terms of and based on (an estimate of) the amount of data that the geometry processing to be performed at the rendering stage for the region would generate, and a threshold amount of such data. Again, this may be assessed and considered using any suitable and desired measure (estimate) of the data that will be produced by the geometry processing for the region.

In an embodiment, this is considered and assessed based on an estimate of the amount of data that geometry processing for a geometry element (e.g. and in an embodiment a packet) will generate (together with the threshold maximum geometry processing “data capacity” that is set).

In this case, the amount of data that geometry processing for a, e.g. packet, will generate, may be assessed and considered in any suitable and desired manner, and using any suitable and desired measure (estimate) of the data that will be produced by geometry processing of, e.g. packets (at the rendering stage).

For example, it could simply be assumed that each geometry element, e.g. packet, will produce a given, same, amount of data for its geometry processing at the rendering stage, in which case the assessment and determination could simply keep a count of how many geometry elements, e.g. packets, are present in a region, and when that count reaches a threshold number of elements, e.g. packets, the rendering of the region triggered. In one embodiment, this is what is done.

The effect of this then will be that for a given region of the render output, the geometry processing for (appropriate), e.g. packets, will initially be allowed to be deferred to the rendering stage (and set to be deferred to the rendering stage), but once a sufficient number of, e.g. packets, for the region have been generated, rendering of the region will be triggered.

Thus, in an embodiment, tracking an amount of geometry processing to be performed at the rendering stage for a (each) region that the render output has been divided into (for tracking purposes) comprises:
maintaining a count of the number of geometry elements (and in an embodiment packets) for the region.

Correspondingly, the technology described herein in an embodiment comprises triggering rendering of a region when the count of geometry elements, e.g. and in an embodiment packets, for the region reaches a (permitted) threshold value.

Correspondingly, in an embodiment of the technology described herein, the method of the technology described herein comprises (and the graphics processor comprises processing circuits configured to) for a render output being generated:
for each region of a plurality of regions that the render output has been divided into for the purposes of tracking the amount of geometry processing to be performed at the rendering stage, maintaining a count of the number of geometry packets that apply to the region; and
when the count of packets for a region reaches a threshold value, triggering rendering of the region.

In these arrangements, the amount of data that will be produced by an, e.g. packet, when its geometry processing is performed at the rendering stage, could be assessed and determined in any suitable and desired manner. For example, this could be estimated by suitable analysis and benchmarking of exemplary graphics content. The maximum permitted threshold number of, e.g. packets, for a region after which rendering is triggered, could then be set in an appropriately conservative manner so that the normal expectation would be that when rendering is triggered, the relevant data should all be able to be stored locally to the graphics processor (as discussed above).

It would also be possible to perform a more sophisticated estimate of the amount of data that would be produced when performing deferred geometry processing, e.g. for a packet at the rendering stage, if desired (with the amount of geometry processing to be performed at the rendering stage, and the threshold amount, being set and measured (tracked) accordingly). For example, an indication of the content of a, e.g. packet, for example, in terms of the number of primitives and/or vertices that it contains, could be used to provide a more accurate estimate of the amount of data that may be generated when performing geometry processing for a, e.g. packet at the rendering stage.

In this case therefore, rather than simply maintaining a count of, e.g. packets, for a region, a total of the number of primitives, and/or number of vertices, and/or of the estimated amount of data that would be produced by the geometry processing at the rendering stage will be maintained, and compared to a threshold amount of primitives, vertices, and/or data for the render output region in question. In some embodiments, that is what is done.

It would be possible in this regard simply to track the total amount of geometry in a region for the purposes of determining whether and when to trigger rendering of geometry for the region, irrespective of whether any processing for the geometry has been deferred to the rendering stage or not, and in one embodiment this is what is done. Thus, in an embodiment, the tracking an amount of geometry processing to be performed at the rendering stage for a region comprises tracking an amount of geometry in the region, in an embodiment in terms of a count of the number of packets, primitives, and/or vertices for the region (and then triggering the rendering of geometry for the region when the amount of geometry in the region reaches a threshold amount).

It would also be possible, if desired, to, rather than simply tracking a total amount of geometry for a region irrespective of whether any processing for the geometry is deferred to the rendering stage or not, track an amount of geometry processing that has been deferred to the rendering stage for a region. Thus, in an embodiment, the tracking an amount of geometry processing to be performed at the rendering stage for a region, and the triggering the rendering of geometry for a region when the amount of geometry processing to be performed at the rendering stage for a region reaches a threshold value, comprise:
tracking an amount of geometry processing that has been deferred to the rendering stage for the region; and
triggering the rendering of geometry for the region when the amount of geometry processing that has been deferred to the rendering stage for a region reaches a threshold value.

In this case, it may be, and is in an embodiment, tracked how many packets, primitives, and/or vertices for a region have had (some of) their geometry processing deferred to the rendering stage, with the number of “deferred” packets, primitives and/or vertices, then being compared to a threshold number of (permitted) deferred packets, primitives and/or vertices for the region, to thereby trigger the rendering of geometry for the region.

The tracking of the amount of geometry processing to be performed at the rendering stage for a region and the determining of whether the amount of geometry has reached the threshold value can be implemented and performed in any suitable and desired manner.

In an embodiment, it is determined which region(s) of the render output a (and each) geometry element, e.g. packet, produced by the sequence of geometry processing stages applies to (e.g. and in an embodiment, by using an appropriate bounding box for the geometry element, e.g. packet), with the geometry processing “tracking” record (e.g. counter) for the region or regions in question then being updated (incremented) accordingly.

Correspondingly, whenever a region geometry processing tracking record (e.g. counter) is updated, in an embodiment the updated record is compared to the appropriate threshold value, to determine whether the threshold value has been reached or not.

In an embodiment, the graphics processor comprises a geometry tracking unit (circuit), e.g., and in an embodiment, (logically) at the end of the sequence of one or more geometry processing stages, that is operable to and configured to maintain, as discussed above, a set of plural geometry processing tracking records (e.g. counters), which can be allocated to and associated with respective “tracking” regions of a render output.

The geometry tracking unit (circuit) is in an embodiment operable to and configured to receive geometry elements, e.g. packets, output by the one or more geometry processing stages, and to update its geometry processing tracking records accordingly, and, compare the records, where appropriate, to the threshold values, and to, where appropriate, trigger the rendering of geometry for a region.

In the case where the tracking of the amount of geometry processing to be performed at the rendering stage for a region simply tracks the total amount of geometry in (for) a region (whether any geometry processing is deferred to the rendering stage for geometry or not), then the geometry tracking should be, and is in an embodiment, performed and updated for each and every geometry element (e.g. packet) that is produced by the sequence of one or more geometry processing stages.

In the case where the tracking tracks geometry processing that has been deferred to the rendering stage, then the geometry tracking should, and in an embodiment does, correspondingly identify geometry elements (e.g. packets) for which geometry processing has been deferred to the rendering stage, and will then update its geometry processing tracking records (only) for geometry elements, e.g. packets, for which geometry processing has been deferred (and will not update the geometry processing tracking records for geometry elements (e.g. packets) for which no geometry processing has been deferred until the rendering stage), and then compare the records, where appropriate, to the threshold values, and to, where appropriate, trigger the rendering of geometry for a region.

In general the threshold is in an embodiment set to (try to) ensure that the geometry resulting from deferred geometry processing is able to be kept locally (on-chip), but in an embodiment also to (try to) ensure that the rendering processing is kept fed with work as the geometry processing progresses (to try to avoid a long tail of fragment processing after geometry processing has completed). A suitable threshold could be of the order of 16 packets, for example.

As discussed above, in the technology described herein, when the amount of geometry processing to be performed at the rendering stage for a region reaches a threshold value, rendering of geometry for the region is triggered. In response to the triggering of rendering of geometry for the region, geometry for the region should be, and is in an embodiment, appropriately rendered.

The rendering that is triggered and performed for a region when the amount of geometry processing for a region reaches a threshold value should, and in an embodiment does, render any geometry that has been processed for the region (for which the desired initial geometry processing has been performed for the region) (at that point) (and which has not already been rendered for the region, e.g. as part of a previous render operation that has already been triggered by the threshold value for geometry for the region previously being reached).

Thus in an embodiment, the rendering of geometry for a region that is performed in response to rendering of geometry for the region being triggered comprises rendering any currently processed geometry for the region that is still to be rendered.

The rendering of geometry for a region that is performed when rendering is triggered for a region should, and in an embodiment does, comprise any suitable and desired rendering that is to be performed for geometry for the region, for example, in dependence on and in accordance with the normal rendering process for the graphics processor and graphics processing pipeline in question. Thus the rendering may comprise, for example, rasterisation and fragment shading, and/or ray tracing processes, etc.

The rendering should, and in an embodiment does, and as will be discussed further below, also trigger and cause to be performed any deferred geometry processing that is still to be performed for the geometry that is being rendered.

Thus, in a particularly embodiment, when rendering of geometry for a region is triggered, the geometry for the region is rendered, including performing any deferred geometry processing for the geometry that is being rendered. In an embodiment any and all currently outstanding deferred geometry processing for geometry for the region is performed when rendering is triggered (and as part of the rendering that is triggered) for a region.

The rendering of a region when the amount of geometry processing to be performed at the rendering stage for a region reaches a threshold value can be triggered in any suitable and desired manner. In an embodiment this is done by sending appropriate signals (e.g. commands) to a “rendering control” circuit of the graphics processor which is then operable to trigger the required rendering of the region.

In an embodiment the geometry tracking unit (circuit) is operable to send appropriate signals (e.g. commands) to trigger the required rendering of a region.

The signal that a region should be rendered, e.g. that is sent to the (control for) the rendering stage should, and in an embodiment does, indicate the rendering that is required. Thus it should, for example, and in an embodiment, indicate the region of the render output for which rendering is to be performed.

The Applicants have further recognised in this regard that when rendering is triggered in the manner of the technology described herein when an amount of geometry processing to be performed at the rendering stage for a region reaches a threshold value, the rendering for the region will be being triggered before all the geometry processing for the render output in question has been completed. This being the case, the Applicants recognise that there may still be further geometry to be rendered for the region in question, after the rendering that is triggered by the threshold value being reached has been performed.

In other words, when rendering is triggered for a region because the amount of geometry processing for the region has reached the threshold, that rendering will only be part of (an increment of) the overall rendering for the region for the render output in question. Thus, the result of rendering the region that is triggered in this regard may not be the final rendered output for the region for the render output in question, but will be an intermediate, “incremental” render of the region that may then need to be appropriately combined with further such “incremental” renders of the region.

Thus, in an embodiment, the (rendering) output generated when rendering geometry for a region in response to the amount of geometry processing to be performed at the rendering stage for a region reaching a threshold value (that is generated from an incremental render for a region that is triggered in the manner of the technology described herein) is stored and retained appropriately for combining with subsequent “incremental” renders for the region (rather than, e.g., simply being written out, to the final output frame (buffer)).

The Applicants have further recognised in this regard that it could be the case that a sequence of plural “incremental” renders will be triggered for a region during the geometry processing for a render output, for example where the amount of geometry processing for a region repeatedly reaches the threshold for triggering rendering of the region.

Thus there may be, in effect, “incremental” renders for a region that do not follow any previous incremental renders for the region for the render output in question, and incremental renders for a region that do follow a previous incremental render or renders for the region. For an incremental render that follows a previous incremental render for a region, the result of the (and all) previous incremental render(s) for the region will need to be retrieved appropriately for combining with the new incremental render for the region.

Thus in an embodiment, when performing rendering of geometry for a region in response to the amount of geometry processing to be performed at the rendering stage for the region reaching a threshold value (an “incremental” render for a region that is triggered in the manner of the technology described herein) that follows a preceding such incremental render for the region, the rendering of geometry for the region comprises using the result of any previously performed rendering for the region (for the render output in question) when performing the rendering of geometry for the region (and in an embodiment combining the result of any previous rendering for the region with the new rendering for the region).

Accordingly, in an embodiment, when the threshold of geometry processing is reached, it is correspondingly indicated that the rendering operation for the region that is triggered is an incremental render such that its output will not be the final output of the region for the render output in question, and/or, and in an embodiment and, whether it follows a previous “incremental render” for the region for the render output in question, such that there will be an earlier rendered version of the region for the render output that needs to be combined with the rendering for the region that is now being performed.

As discussed above, the rendering that is triggered when the amount of geometry processing to be performed at the rendering stage for a region reaches a threshold value should, and in an embodiment does, have the effect of causing any “current” (and outstanding) deferred geometry processing for the region to be completed (as part of the rendering processing). Accordingly, once the rendering for the region has been completed, a new record (count) of an amount of geometry processing to be performed at the rendering stage can be, and is in an embodiment begun (with rendering for the region then again being triggered if and when the amount of (new) geometry processing to be performed at the rendering stage for the region exceeds the threshold).

Thus, in an embodiment, when the amount of geometry processing to be performed at the rendering stage for a region reaches a threshold value, as well as triggering rendering of geometry for the region, the tracking of the amount of geometry processing to be performed at the rendering stage for the region is reset (restarted) (e.g., and in an embodiment, the geometry processing tracking record (e.g. counter) for the region is reset (cleared)), so as to begin a new measure (count) of the amount of geometry processing to be performed at the rendering stage for the region (for then comparing to the threshold value).

This should be, and is in an embodiment, done each time an “incremental” render for a region of the render output is triggered, such that there may be, for example, and in an embodiment, for a given region (and in dependence upon how much geometry is present in the region), a sequence of geometry processing “counts” followed by incremental renders of the region, until all the geometry for the render output in question has been processed.

Thus, in an embodiment, when the amount of geometry processing to be performed at the rendering stage for a region reaches a threshold value, rendering of geometry for the region is triggered, any outstanding deferred geometry processing for the region is performed, and the geometry processing tracking for the region is reset (restarted).

The above discusses the triggering of rendering for a region of a render output when the amount of geometry processing for the region reaches a threshold value. The Applicants have further recognised in this regard that rendering of regions of a render output will also need to be performed (and correspondingly triggered) when all of the geometry for a render output has been (initially) processed.

Thus, in an embodiment, the method of the technology described herein comprises (and the graphics processor is correspondingly configured to (comprises a processing circuit configured to)), when all of the geometry for a render output has been processed, triggering the rendering of geometry for a (and in an embodiment for each region (for all regions)) of the render output.

Correspondingly, when the end of the geometry processing for a render output is reached, the rendering of geometry for all of the regions of the render output is appropriately triggered (and correspondingly performed).

This “end of render output” rendering can be triggered and controlled in any suitable and desired manner. In an embodiment, the tracking of the amount of geometry processing for a region (the geometry tracking unit (circuit)) is in an embodiment operable to and configured to also identify the end of geometry processing for a render output, and to, in that event, then trigger the rendering of geometry for a region (and for all of the regions) of the render output.

The end of the geometry processing for a render output can be identified in this regard in any suitable and desired manner. For example, the sequence of geometry processing may include a suitable indication, such as an “end of render pass” indication, that can be used to identify the end of geometry processing for a render output.

The effect of this then will be to cause any outstanding rendering that remains to be completed for the render output in question to be completed.

When triggering and performing rendering at the end of the geometry processing for a render output in this manner, in an embodiment, the rendering of the regions for the render output is triggered and performed in turn, e.g. in a suitable order, such as raster order or Z order. Other arrangements would, of course, be possible.

In this case, each and every region of the render output could be sent for a “final” render in this manner, or it could, firstly, be identified whether a region has any outstanding geometry to be rendered, with only those regions that have outstanding geometry to be rendered being sent for rendering.

Again, the rendering of geometry for a region in this manner can comprise any suitable and desired rendering that is to be performed for geometry for the region, for example, and in an embodiment, in dependence on and in accordance with the normal rendering process for the graphics processor for the graphics pipeline in question. Again, this rendering should, and in an embodiment does, also cause any deferred geometry processing that is still to be performed for the geometry that is being rendered to be performed.

The rendering of the regions of a render output when all the geometry for a render output has been (initially) processed (when the end of the render output is reached) can be triggered in any suitable and desired manner. Again, in an embodiment this is done by sending appropriate signals (e.g. commands) to a “render control” circuit of the graphics processor which is then operable to trigger the required rendering of the region(s) in question.

Again, the signal that a region should be rendered in this regard should, and in an embodiment does, indicate the region of the render output for which rendering is to be performed. It in an embodiment also indicates that the rendering to be performed for the region is the “final” render for the region for the render output in question (as as there will be no more geometry to be processed for the region, there will correspondingly be no further rendering to be performed for the region once the rendering in question has been performed). Correspondingly, such a “final” render indication in an embodiment indicates, and/or is interpreted to indicate, that the rendering result of that “final” render for the region should be appropriately written out as part of the overall, final, render output for the render output in question (e.g. to an appropriate frame buffer for the render output in memory).

The Applicants have similarly recognised that such a “final” render for a region may follow one or more previous “incremental renders” for the region for the render output in question (as discussed above). Again, this can correspondingly be indicated in relation to the final rendering operation for the region, i.e. to indicate, where appropriate, that there is an earlier rendered version of the region for the render output that needs to be combined with the rendering for the region that is now being performed.

In an embodiment, it can correspondingly also be indicated for a “final” render output that that render output does not follow any previous “incremental” renders for the render output region in question, such that the rendering in that case does not need to be combined with any rendering result from an earlier “incremental” render of the region.

Correspondingly, once a render output region has been sent for a “final” render, and/or once the rendering of a render output has been completed, the corresponding geometry processing tracking for the region/render output in question can be, and is in an embodiment, cleared (discarded), e.g., and in an embodiment, so that geometry processing tracking for a new render output can be performed.

It will be appreciated from the above, that in operation of the technology described herein, for a given render output, there may be zero or more regions of the render output that are subjected to a single “incremental” render followed by a “final” render, zero or more regions of a render output that are subjected to plural “incremental” renders followed by a “final” render, and zero or more regions that are simply subjected to a “final” render (and that do not undergo any “incremental” rendering), in particular in dependence upon the relative “complexity” (in terms of the amount of geometry) of different regions of the render output. Correspondingly, the technology described herein should, and in an embodiment does, have the effect, of only triggering incremental renders for regions of a render output for regions that are more complex (contain more geometry), such that any incremental rendering should only be performed for regions of a render output where that is actually required.

Correspondingly, an overall render output will be rendered as a plurality of separate regions of that output, with the overall render output then being formed by combining the respective (final) rendered outputs for each (individual) region.

Correspondingly, when a region of the render output that is being considered is larger than an individual rendering tile, the region is in an embodiment still rendered as respective individual rendering tiles (on a rendering tile-by-rendering tile basis).

As discussed above, the rendering of a render output region in an embodiment comprises (and the graphics processor is in an embodiment configured to) determining which geometry, e.g. packets, need to be processed when rendering the region, whether any of that geometry (those packets) require further (deferred) geometry processing to be performed, and then performing any required further (deferred) geometry processing (further packet processing for packets), as required, and once any necessary deferred geometry processing (packet processing) has been performed for geometry, e.g. packets, that apply to the region, then performing the rendering/fragment processing of the geometry for the region.

Thus, the rendering (the rendering stage) in an embodiment comprises an initial process of using the binning data structure(s) generated by the binning stage to identify geometry, e.g. packets, to be processed for the region being rendered.

It can be, and is in an embodiment, determined whether further geometry processing needs to be performed for geometry, e.g. a packet, when rendering a region by identifying that there is a “deferred geometry processing” indicator that associated with the geometry, e.g. a packet (as discussed above), e.g. stored for and with the geometry, e.g. packet, in the binning data structure(s), to thereby determine that geometry processing has been deferred for the geometry, e.g. packet.

When it is determined that geometry processing for geometry, e.g. a packet, has been deferred, then the geometry processing that was deferred for the geometry, e.g. packet, will be performed at the rendering stage. (Thus references herein to deferring geometry processing to the rendering stage refer to an intention to defer that geometry processing until after a binning data structure or structures has been used to identify geometry, e.g. packets, to be processed for a render output region (and deferring that geometry processing until after a binning data structure or structures has been used to identify geometry, e.g. packets, to be processed for a render output region), unless triggered and performed by some other event or operation (after being initially “deferred”). Similarly, the further geometry processing that is performed for geometry, e.g. a packet, that has been determined as needing to be processed further for a region is correspondingly performed after (at least an initial) binning stage/process.)

The performance of the deferred geometry processing at the rendering stage can be triggered and controlled in any suitable and desired manner, and may be performed by any suitable and desired element and component of the graphics processor and of the graphics processing pipeline that is being executed.

In an embodiment, the binning stage triggers and controls the performance of any deferred geometry processing for geometry at the rendering stage (and in an embodiment in a corresponding manner to controlling and triggering the performance or not of the geometry processing that is (or is not) deferred as part of the (initial) geometry processing, as discussed above).

Once the deferred geometry processing for, e.g. a packet, has been completed, such that the packet has at that point been “completely” geometry processed, then in an embodiment, the binning stage operates to process the (now finished) (geometry) packet from the (complete) geometry processing, to generate a processed (primitive) packet therefrom (as discussed above).

As will be appreciated from the above, when performing deferred geometry processing for geometry, e.g. a packet, at the rendering stage, the result of that processing (e.g. the processed (primitive) packet and any updated binning data structure(s)), will need to be stored for use when rendering the tile in question.

The geometry, e.g. packet, and other data that is generated at this point can be stored in any suitable and desired manner. As discussed above, in an embodiment, it is stored as and in storage that is intended to have a shorter lifetime than the storage where completed geometry, e.g. primitive packets, and binning data structures that are generated by the binning stage prior to the rendering stage are stored.

The Applicants have recognised in this regard that while fully (geometry) processed geometry, e.g. primitive packets, that are generated prior to and as part of the binning stage may need to be retained as (intermediate) data for, e.g., the entirety, of the time while a render output is being generated in its entirety, any fully processed geometry, e.g. (primitive) packets, that are generated by performing deferred geometry shading at the rendering stage may only be required when rendering the render output region in question that the geometry, e.g. packet, has been determined as applying to.

In this case therefore, any later, fully geometry processed geometry, e.g. primitive packets, may be able to be discarded once the render output region to which they apply has been rendered, such that that geometry (those packets) can be, and are in an embodiment, discarded once they have been used. (Whereas any fully processed geometry, e.g. primitive packets, that are generated as part of the initial geometry processing pipeline and binning stage should be retained until the render output itself has been completed, as it may not be possible to determine when that geometry (those packets) will no longer be needed during the rendering process for the render output in question.)

In an embodiment, and where the graphics processor has the processing resources (e.g. processing (shader) cores) to support such operation, once the rendering/fragment processing for a region of a render output (e.g. draw call) has been started, the corresponding processing of a next region to be processed for the render output in question, and in particular the determination of whether there is any geometry (e.g. are any packets) for which geometry processing has been deferred for the next region, and the triggering and the performance of that deferred geometry processing, is in an embodiment started and performed before the rendering/fragment processing has finished for the preceding region of the render output. In other words, in an embodiment, the determination of geometry, e.g. packets, to be processed for a region, and the triggering and performance of any deferred geometry processing for geometry, e.g. packets, for that region is in an embodiment started while rendering/fragment processing is being performed for a preceding region of the render output in question (or for a different render output). This can then facilitate more efficient processing of a given render output.

A render output for which the amount of geometry processing to be performed at the rendering stage is tracked in the manner of the technology described herein can be any suitable and desired render output that the graphics processing being performed can be subdivided into (and that is identifiable (identified) as a distinct and separate (render) output of the overall graphics processing being performed). In an embodiment, the render output corresponds to a subset of the processing for producing an overall output, such an output frame (e.g. to be displayed). Thus the render output is in an embodiment one of a sequence of plural render outputs that together serve for generating an output frame or sequence of output frames.

In an embodiment, a (each) render output being considered in this regard comprises a (single) draw call, i.e. such that the geometry processing is tracked for draw calls (and a draw call) as a whole, i.e. on a draw call-by-draw call basis.

The above describes the main elements and operation of the graphics processor and graphics processing pipeline that are relevant to operation in the manner of the technology described herein.

As will be appreciated by those skilled in the art, the graphics processor can otherwise include and execute, and in an embodiment does include and execute, any one or one or more, and in an embodiment all, of the processing stages and circuits that graphics processors and graphics processing pipelines may (normally) include.

In an embodiment, the graphics processor comprises, and/or is in communication with a memory system, one or more memories, and/or memory devices that store the data described herein, and/or that store software for performing the processes described herein. The graphics processor may also be in communication with a host microprocessor, and/or with a display for displaying images based on the output of the graphics processor.

The overall output being generated may comprise any output that can and is to be generated by the graphics processor and processing pipeline. Thus it may comprise, for example, a frame of output fragment data. The technology described herein can be used for all forms of output that a graphics processor and processing pipeline may be used to generate, such as frames for display, render to texture outputs, etc. In an embodiment, the output is an output frame, and in an embodiment an image.

In an embodiment, the various functions of the technology described herein are carried out on a single graphics processing platform that generates and outputs the (rendered) data that is, e.g., written to a frame buffer for a display device.

The various functions of the technology described herein can be carried out in any desired and suitable manner. For example, unless otherwise indicated, the functions of the technology described herein herein can be implemented in hardware or software, as desired. Thus, for example, unless otherwise indicated, the various functional elements, stages, and “means” of the technology described herein may comprise a suitable processor or processors, controller or controllers, functional units, circuitry, circuits, processing logic, microprocessor arrangements, etc., that are configured to perform the various functions, etc., such as appropriately dedicated hardware elements (processing circuits/circuitry) and/or programmable hardware elements (processing circuits/circuitry) that can be programmed to operate in the desired manner.

It should also be noted here that, as will be appreciated by those skilled in the art, the various functions, etc., of the technology described herein may be duplicated and/or carried out in parallel on a given processor. Equally, the various processing stages may share processing circuitry/circuits, etc., if desired.

Furthermore, unless otherwise indicated, any one or more or all of the processing stages of the technology described herein may be embodied as processing stage circuits, e.g., in the form of one or more fixed-function units (hardware) (processing circuits), and/or in the form of programmable processing circuits that can be programmed to perform the desired operation. Equally, any one or more of the processing stages and processing stage circuitry of the technology described herein may be provided as a separate circuit element to any one or more of the other processing stages or processing stage circuits, and/or any one or more or all of the processing stages and processing stage circuits may be at least partially formed of shared processing circuits.

Subject to any hardware necessary to carry out the specific functions discussed above, the graphics processor can otherwise include any one or more or all of the usual functional units, etc., that graphics processors include.

It will also be appreciated by those skilled in the art that all of the described embodiments of the technology described herein can, and, in an embodiment, do, include, as appropriate, any one or more or all of the features described herein.

The methods in accordance with the technology described herein may be implemented at least partially using software e.g. computer programs. It will thus be seen that the technology described herein herein may provide computer software specifically adapted to carry out the methods herein described when installed on a data processor, a computer program element comprising computer software code portions for performing the methods herein described when the program element is run on a data processor, and a computer program comprising code adapted to perform all the steps of a method or of the methods herein described when the program is run on a data processing system. The data processor may be a microprocessor system, a programmable FPGA (field programmable gate array), etc.

The technology described herein also extends to a computer software carrier comprising such software which when used to operate a display controller, or microprocessor system comprising a data processor causes in conjunction with said data processor said controller or system to carry out the steps of the methods of the technology described herein. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein need be carried out by computer software and thus, in a further broad embodiment the technology described herein provides computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions either fixed on a tangible, non-transitory medium, such as a computer readable medium, for example, diskette, CDROM, ROM, RAM, flash memory, or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink-wrapped software, preloaded with a computer system, for example, on a system ROM or fixed disk, or distributed from a server or electronic bulletin board over a network, for example, the Internet or World Wide Web.

Embodiments of the technology described herein will now be described.

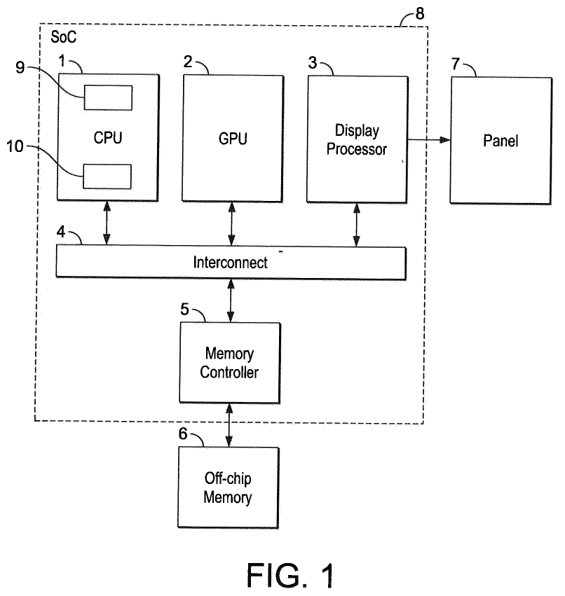

FIG. 1 shows an exemplary system on chip (SoC) graphics processing system 8 that comprises a host processor comprising a central processing unit (CPU) 1, a graphics processor (GPU) 2, a display processor 3, and a memory controller 5. As shown in FIG. 1, these units communicate via an interconnect 4 and have access to off-chip memory 6. In this system, the graphics processor 2 will render frames (images) to be displayed, and the display processor 3 will then provide the frames to a display panel 7 for display.

In use of this system, an application 9 such as a game, executing on one or more host processors (CPUs) 1 will, for example, require the display of frames on the display panel 7. To do this, the application will submit appropriate commands and data to a driver 10 for the graphics processor 2, e.g. that is executing on a CPU 1. The driver 10 will then generate appropriate commands and data to cause the graphics processor 2 to render appropriate frames for display and to store those frames in appropriate frame buffers, e.g. in the main memory 6. The display processor 3 will then read those frames into a buffer for the display from where they are then read out and displayed on the display panel 7 of the display.

In the present embodiment, the graphics processor 2 executes a graphics processing pipeline that processes graphics primitives, such as triangles, when generating an output, such as an image for display.

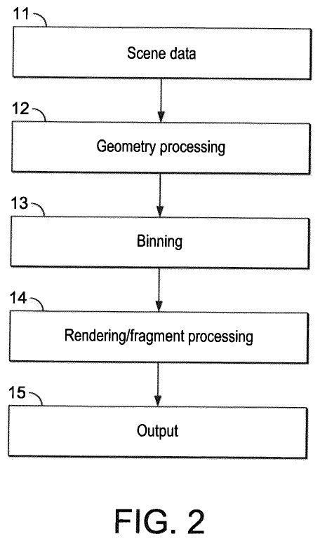

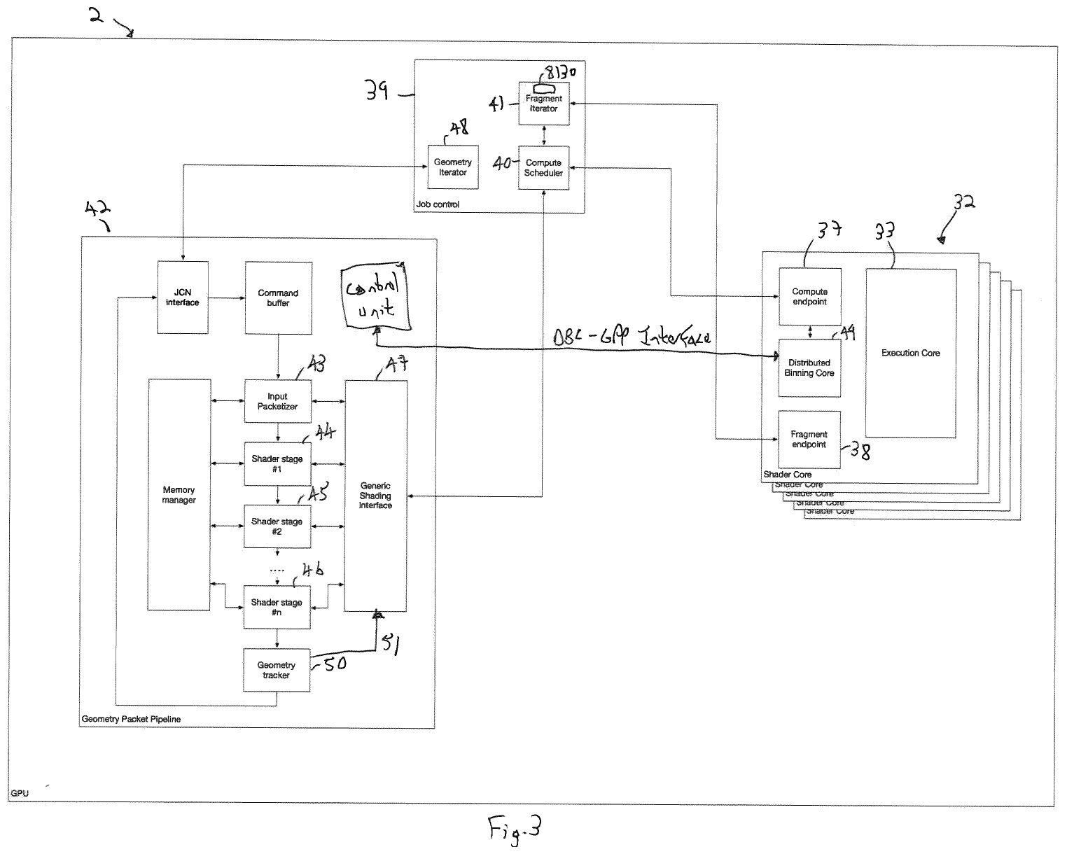

FIG. 2 shows schematically the processing sequence of the graphics processing pipeline executed by the graphics processor 2 when generating an output in the present embodiments.

FIG. 2 shows the main elements and pipeline stages. As will be appreciated by those skilled in the art there may be other elements of the graphics processor and processing pipeline that are not illustrated in FIG. 2. It should also be noted here that FIG. 2 is only schematic, and that, for example, in practice the shown pipeline stages may share significant hardware circuits, even though they are shown schematically as separate stages in FIG. 2. It will also be appreciated that each of the stages, elements and units, etc., of the processing pipeline as shown in FIG. 2 may, unless otherwise indicated, be implemented as desired and will accordingly comprise, e.g., appropriate circuitry, circuits and/or processing logic, etc., for performing the necessary operation and functions.

As shown in FIG. 2, for an output to be generated, a set of, e.g. scene data 11, including, for example, and inter alia, a set of vertices (with each vertex having one or more attributes, such as positions, colours, etc., associated with it), a set of indices referencing the vertices in the set of vertices, and primitive configuration information indicating how the vertex indices are to be assembled into primitives for processing when generating the output, is provided to the graphics processor, for example, and in an embodiment, by storing it in the memory 6 from where it can then be read by the graphics processor 2.

This scene data may be provided by the application (and/or the driver in response to commands from the application) that requires the output to be generated, and may, for example, comprise the complete set of vertices, indices, etc., for the output in question, or, e.g., respective different sets of vertices, sets of indices, etc., e.g. for respective draw calls to be processed for the output in question. Other arrangements would, of course, be possible.

There is then a geometry processing stage or stages 12, which performs appropriate geometry processing of and for the scene data to generate the data that will then be required for rendering the output. This geometry processing 12 can comprise any suitable and desired geometry processing that may be performed as part of a graphics processing pipeline.

In the present embodiments, this geometry processing comprises at least performing vertex processing (vertex shading) of attributes for vertices to be used for primitives for the render output being generated. In particular, appropriate vertex position shading is performed to transform the positions for the vertices from the, e.g. “model” space in which they are initially defined, to the, e.g., “screen”, space that the output is being generated in. In embodiments, the vertex shading also comprises generating and/or processing other, non-position attributes of vertices (varyings/varying shading). It would also be possible for some or all the varying shading to be deferred from the geometry processing and, for example, to be triggered at the binning or rendering stages instead, if desired.

As well as appropriate vertex shading, the geometry processing may comprise any other form of geometry processing that is desired, such as one or more of tessellation shading, transform feedback shading, mesh shading, or task shading. This geometry shading may also generate and/or process attributes for vertices, and/or it may process and generate attributes for primitives as well.

Once the desired geometry processing has been performed, there is then, in the present embodiments, as shown in FIG. 2, a binning/tiling stage 13. (It is assumed in this regard that the graphics processor 2 in the present embodiments is a tile-based graphics processor and so generates respective output tiles of an overall output (e.g. frame) to be generated separately to each other, with the set of tiles for the overall output then being appropriately combined to provide the final, overall output.) The binning process operates to generate appropriate data structures for determining which primitives need to be processed for respective rendering tiles of the output being generated. For example, it may sort the primitives into appropriate primitive lists, which indicate the primitives to be processed for respective tiles or sets of tiles. Alternatively, it may generate other data structures, such as hierarchies of bounding boxes, that can then be used at the rendering/fragment processing stage to identify those primitives that need to be processed for a respective tile.

The binning/tiling process 13 may also cull primitives that are not visible (e.g. that fall outside the view frustum, and/or based on the facing direction of the primitives).

As part of the geometry processing and/or the binning/tiling operation the primitives to be processed will be “assembled”. The primitives will, as discussed above, be assembled from a set of indices referencing vertices in a set of vertices for the render output processing being performed, based on primitive configuration information indicating how the vertex indices are to be assembled into primitives for processing when generating the render output.

Such primitive assembly may be performed as part of and at an appropriate stage of the geometry processing and/or as part of the binning/tiling processing, as desired. There may also, if desired, be two (or more) “primitive assembly” operations. For example, an initial primitive assembly operation could be performed to identify those vertices that will actually be used for the render output being generated before performing any vertex shading of the vertices, but with there then being a later primitive assembly stage that provides a sequence of assembled primitives for the binning/tiling stage.

Once the binning/tiling process has generated the necessary data structures for identifying the primitives to be processed for respective tiles of the render output, the primitives can then be and are then subjected to appropriate rendering/fragment processing 14. This operation is performed in the present embodiments on a tile-by-tile basis, using the data structures generated by the tiling/binning process 13 to identify those primitives that need to be processed for a respective tile.

The rendering/fragment processing can comprise any suitable and desired rendering and fragment processing operations that may be performed. Thus it may comprise, for example, first rasterising primitives to be processed for a tile to fragments, and then processing those fragments accordingly (e.g., and in an embodiment, by performing appropriate fragment shading of the fragments). The rendering/fragment processing may also or instead comprise performing ray tracing operations, such as performing the rendering by tracing rays for respective fragments representing respective sets of one or more sampling positions of the output being generated. Hybrid ray tracing operations would also be possible, if desired.

The output of the rendering/fragment processing (the rendered fragments) is written to a tile buffer (not shown). Once the processing for the tile in question has been completed, then the tile will be written to an output data array in memory 6, and the next tile processed, and so on, until the complete output data array 15 has been generated. The process will then move on to the next output data array (e.g. frame), and so on.

The output data array may typically be an image for a frame intended for display on a display device, such as a screen or printer, but may also, for example, comprise intermediate render data intended for use in later rendering passes (also known as a “render to texture” output), or for deferred rendering, or for hybrid ray tracing, etc.

FIG. 3 shows an embodiment of a graphics processor (GPU) 2 that can execute a graphics processing pipeline of the form shown in FIG. 2, and that can be operated in the manner of the technology described herein.

As shown in FIG. 3, the graphics processor 2 comprises a plurality of processing (shader) cores 32 which are each operable to execute (shader) programs to perform processing operations. As shown in FIG. 3 each shader core 32 to facilitate this comprises a programmable execution unit (execution core) 33 that is operable to execute program instructions to perform processing operations.

In the present embodiments, the shader cores 32 are operable to execute both “compute” shader programs (to perform so-called compute shading) and fragment shader operations. Thus as shown in FIG. 3, each shader core 32 comprises an appropriate compute endpoint 37 and fragment endpoint 38 that act as the control interface for performing compute shading and fragment processing, respectively, and that will, for example, and in an embodiment, trigger the execution core 33 to execute the appropriate compute shading or fragment shading tasks, as required.

As shown in FIG. 3, the compute endpoint 37 and fragment endpoint 38 receive appropriate processing tasks from a job control unit 39 of the graphics processor 2, which job control unit 39 includes an appropriate compute scheduler 40 and fragment iterator 41 for distributing processing jobs that the job controller 39 receives as appropriate processing jobs to the shader cores 32.

As discussed above, when performing graphics processing, there will typically be an initial geometry processing stage that determines the vertex and other data that is necessary for generating the graphics processing output in question, which will then be followed by a rendering/fragment processing stage for processing (rendering) that geometry.

In the present embodiments, the geometry processing is performed, as shown in FIG. 3, by a geometry packet pipeline 42 of the graphics processor 2. This geometry packet pipeline is operable to trigger the performance of one or more “geometry” shader stages (which shader stages themselves will be executed by the shader cores 32, under the control of the geometry packet pipeline 42).

For example, as shown in FIG. 3, the geometry packet pipeline 42 comprises an input packetizer 43 that can trigger position shading and vertex shading by the shader cores 32. It also includes further shader stage circuits 44, 45, 46 that are operable to trigger compute shaders for performing geometry processing, such as task shaders, mesh shaders, tessellation shaders, etc. (which again will be executed by the shader cores 32).

As shown in FIG. 3, the geometry packet pipeline 42 has an appropriate interface 47 to the compute scheduler 40 of the job control unit 39, via which it can control and trigger the performance of appropriate geometry shading operations by the shader cores 32.

As shown in FIG. 3, the geometry packet pipeline 42 also includes a geometry tracker unit (circuit) 50 at the end of the pipeline. The operation of this element will be described in more detail below.

The overall operation of the geometry packet pipeline 42 is controlled by the job control unit 39 (by a geometry iterator 48 of the job control unit 39) which distributes the appropriate geometry processing jobs and tasks to the geometry packet pipeline 42.

The graphics processor 2 of FIG. 3 is configured to perform rendering in a tile-based manner (as discussed above). To facilitate this, as shown in FIG. 3, each shader core 32 also includes a distributed binning core 49 that is operable to generate appropriate data structures for determining which primitives need to be processed for respective rendering tiles of the output being generated.

In the present embodiments, the distributed binning cores 49 generate hierarchies of bounding boxes for primitives and primitive packets (that contain primitives to be rendered) (which are then used at the rendering/fragment processing stage to identify those primitives that need to be processed for a respective tile).

The distributed binning cores 49 may also cull primitives that are not visible (e.g. that fall outside the view frustum, and/or based on the facing direction of the primitives).

The distributed binning cores 49 can operate in any suitable and desired manner for this purpose.

The distributed binning cores 49 of the shader cores 32 may trigger vertex shading, such as varying shading, as part of their operation (e.g. where varying shading was not performed by the input packetizer as part of the input packetizer 43 operation).

In the present embodiments, the rendering/fragment processing is performed by executing appropriate fragment processing operations on a shader core 32 under the control of the fragment endpoint 38. To facilitate this, the fragment endpoint 38 of each shader core is operable to trigger appropriate fragment shader operation by a shader core.

As will be appreciated from the above, in operation of the present embodiments, the geometry packet pipeline 42 that performs the geometry processing will generate appropriate geometry data, such as (transformed) vertex positions, vertex varyings, and primitive attributes, which data will then be used, for example, by the binning/tiling processing and rendering/fragment processing of the later stages of the graphics processing pipeline.

In the present embodiments, the geometry packet pipeline 42 operates to generate respective geometry packets containing the data that it generates. In the present embodiments, those geometry packets are then processed by the distributed binning cores 49 to generate corresponding primitive packets, which primitive packets are then used by the fragment processing (fragment shaders) 52.

Thus, in the present embodiments, the geometry packet pipeline 42 will generate geometry packets that store attributes for vertices and primitives, which geometry packets will then be read and used by the distributed binning cores 49.

Correspondingly, the distributed binning cores 49 will generate appropriate primitive packets storing attributes for vertices and primitives, which primitive packets will then be read and used by the fragment processing 38.

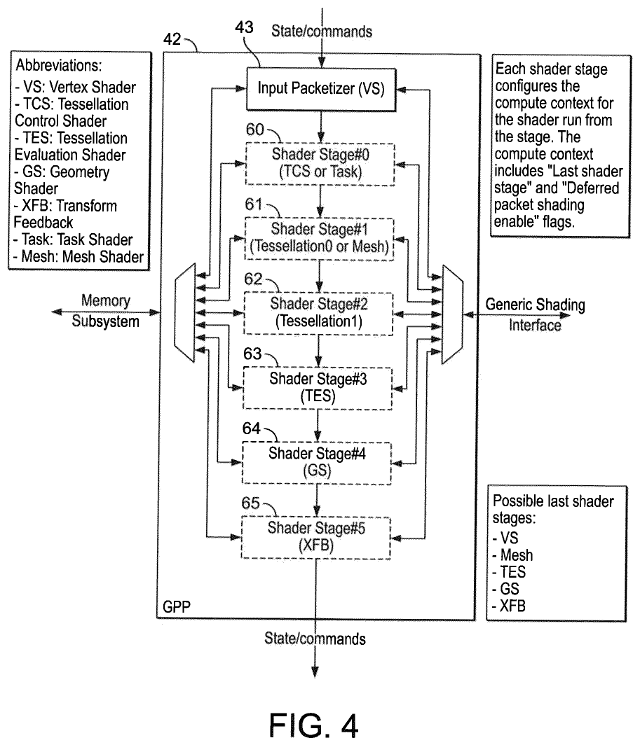

FIG. 4 shows the geometry packet pipeline 42 of the present embodiments in more detail.

As shown in FIG. 4, in the present embodiments the geometry packet pipeline 42 comprises (can trigger the execution of) (up to) six shader stages, an input packetizer 43 (that can trigger vertex shading (VS)); a next shader stage 60 that can trigger tessellation control shading or task shading; a next shader stage 61 that can trigger tessellation shading or mesh shading; a next shader stage 62 that can trigger further tessellation shading; a next shader stage 63 that can trigger tessellation evaluation shading; a next shader stage 64 that can trigger geometry shading; and a final shader stage 65, that can trigger transform feedback shading.

In the present embodiments, when executing the geometry packet pipeline for a render output (e.g. for a draw call), the various shader stages shown in FIG. 4 can be selectively enabled. In other words, not every execution of the geometry packet pipeline 42 will include all the shader stages shown in FIG. 4, but selective shader stages can be omitted from the geometry packet pipeline 42 that is being executed.

In any event, and irrespective of any preceding shader stages that are activated, in the present embodiments, the shader stages that can potentially be the last shader stage of any given geometry processing pipeline are the vertex shader (input packetizer 43); the mesh shader (shader stage 61), the tessellation evaluation shader (stage 63), the geometry shader (stage 64) and the transform feedback shader (stage 65).

One of these shader stages will always be the last shader stage in a given geometry packet pipeline that is being executed in the embodiments of the technology described herein. (Any shader stages that are omitted in the geometry packet pipeline actually being executed are disabled, so that packets will, in effect, simply pass through those stages without being processed.)

In operation, each shader stage of the geometry packet pipeline 42 will configure the compute context for the shader that is run from the stage in question. In the present embodiments, the compute context that is configured for a (and each) shader stage includes an indication of whether the shader stage in question is the last shader stage for the geometry processing pipeline being executed, and whether “deferred packet shading” has been enabled or not. In the present embodiments, the compute context for each shader stage includes appropriate flags that can be set to indicate this.

In the present embodiments, the first, input packetizer stage 43 of the geometry pipeline 42 of the present embodiments generates respective initial geometry packets storing data for sets of primitives to be processed for the render output being generated.

To do this, the input packetizer 43 assembles primitives using lists of vertex indices indicating vertices to be used to assemble primitives for the render output being generated based on appropriate primitive configuration information indicating how the lists of vertices should be assembled into primitives, and then assigns the assembled primitives to packets in order. In the present embodiments, a packet has a fixed capacity, e.g. an upper limit of vertices and/or primitives, and when the fixed capacity is reached, a new packet is started. Appropriate memory space for storing a packet is also allocated.

The (geometry) packets generated by the input packetizer 43 are then passed to the next (enabled) shader stage (if any) for processing, with that shader stage then performing appropriate processing of the packets that it receives and generating corresponding output packets, which are then passed on to the next shader stage of the geometry packet pipeline 42 (if any), and so on, until the final shading stage of the geometry packet pipeline being executed is reached (which as discussed above will be indicated as such).

In the present embodiments, when the last shader stage of the geometry packet pipeline being executed is reached for a packet, a packet shading request is sent for the last shader of the geometry packet pipeline to be executed for the packet, but rather than the last shader of the geometry packet pipeline being executed simply being executed on the shader cores 32 for the packet, the packet is instead first processed by a distributed binning core 49 of a shader core.

In particular, the “last” shader stage packet shading request for a packet is sent to the compute endpoint 37 of the shader core 32 in question which then signals the distributed binning core 49 accordingly.

The distributed binning core 49 then determines whether to defer the final shader stage of the geometry packet pipeline for the packet, or perform that last shader stage of the geometry packet pipeline being executed for the packet immediately.

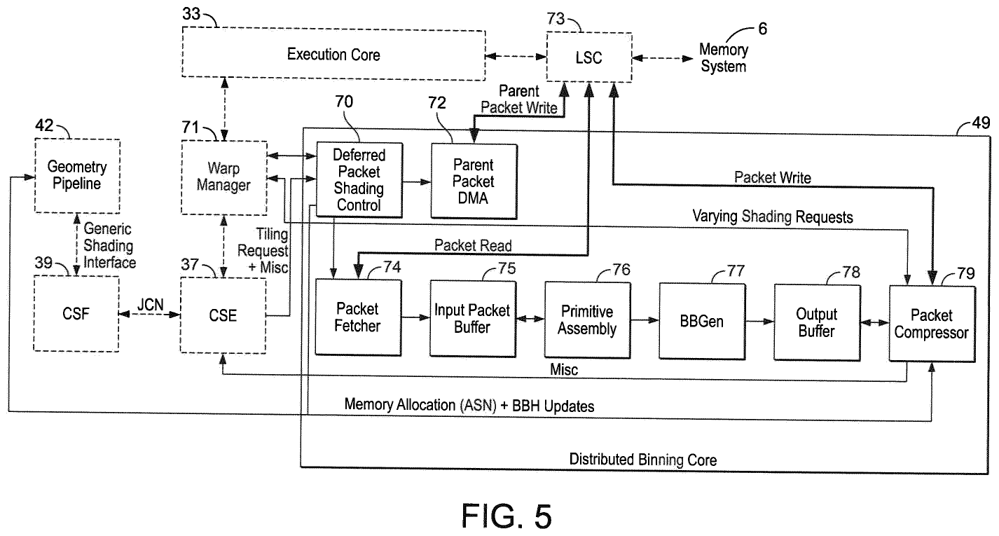

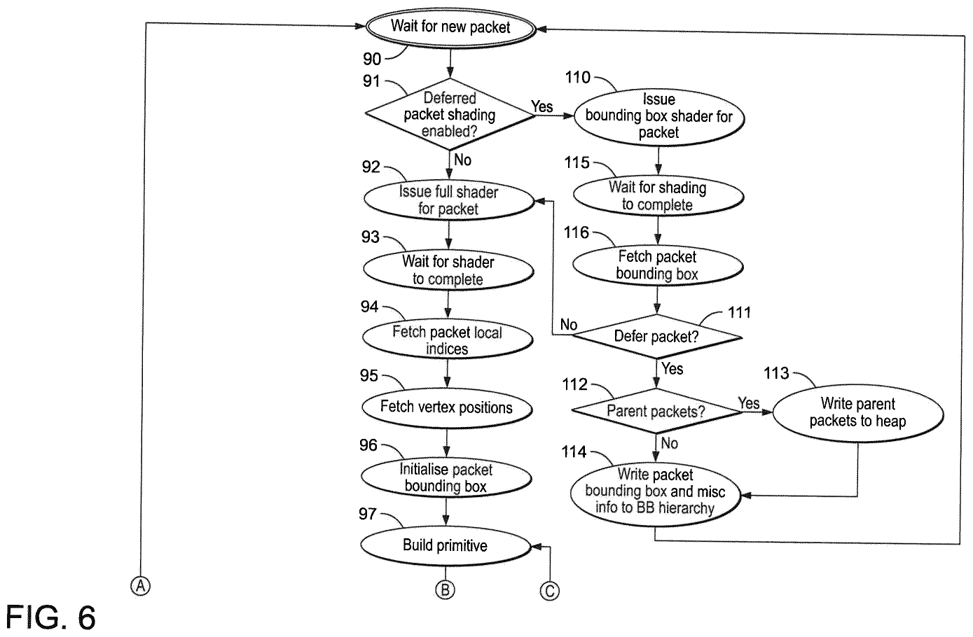

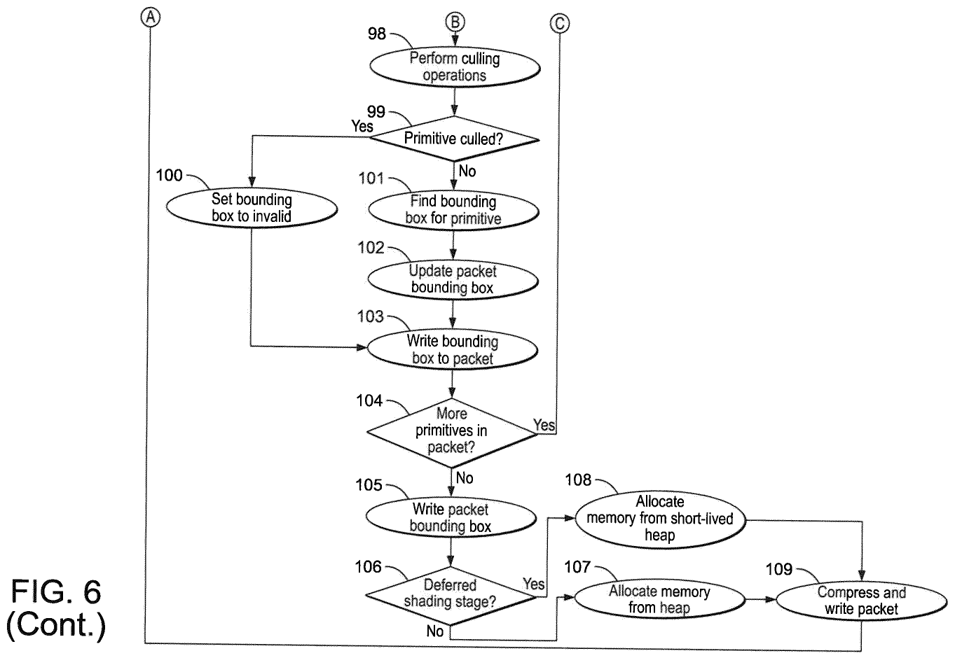

FIGS. 5 and 6 show the operation of a distributed binning core 49 in this regard in the present embodiments. FIG. 5 is a block view of a distributed binning core 49 showing elements of that core that are relevant to this operation. FIG. 6 is a flow chart showing the distributed binning core operation in the present embodiments.

As shown in FIG. 5, the distributed binning core includes a deferred packet shading control unit/circuit 70 that receives appropriate processing requests from the compute shader endpoint 37 when a last shader stage is to be executed for a packet.

As will be discussed further below, the deferred packet shading control 70 determines whether the last shading stage for the packet should be deferred or not, and then either triggers the shading for the packet, or defers that shading, accordingly. As shown in FIG. 5, to facilitate this, the deferred packet shading control unit 70 has an appropriate interface to a warp manager 71 for issuing shading processing to its associated execution core 33.

The deferred packet shading control unit 70 also controls a “parent packet” DMA unit 72 that is operable to write the “parent” packet (i.e. the geometry packet that is still to undergo its last shading stage) to memory (via, for example, a load store cache 73 of the shader core) in the case where the last shading stage is deferred (as if the last shading stage is deferred, the “parent” packet for that shading stage will be required for executing that shading stage later on in the processing (in a deferred manner)).

As shown in FIG. 5, the distributed binning core includes an appropriate packet processing pipeline 49, which is used to generate appropriate primitive packets for processing by the rendering/fragment processing from the geometry packets that it receives, and to also generate the appropriate data structures (which in the present embodiments are hierarchies of bounding boxes for packets) to allow the rendering/fragment processing to determine which packets need to be processed for a given rendering tile.

Thus as shown in FIG. 5, the distributed binning core packet processing pipeline comprises a packet fetcher 74 which is operable to fetch packets to be processed from the memory, and an input packet buffer 75 for buffering the packets while they are processed. A primitive assembly stage (circuit 76) is operable to assemble primitives in packets and, where appropriate, perform culling operations for the primitives. The assembled primitives (that are not culled) are then passed to a bounding box generation stage/circuit 77, with the processed primitives, etc., then being stored in an output buffer 78 until the relevant primitive packet is completed (at which point the packet will be compressed 79 and then written out to memory).

As shown in FIG. 5, the distributed binning core can also trigger vertex varying shading for vertices in a packet, if required, for example where that has not been performed as part of the geometry packet pipeline execution.

FIG. 6 shows the operation of the distributed binning core 49 when a packet shading request for the last shader of the geometry packet pipeline being executed is received for a packet.

As shown in FIG. 6, when such a shading request for a packet is received (step 90), it will first be determined whether deferred packet shading has been enabled (step 91).

If deferred packet shading has not been enabled then the last shading stage of the geometry packet pipeline being executed will be performed immediately (triggered by the deferred packet shading control 70 of the distributed binning core).

Thus in this case, the full shader (the last shading stage for the geometry packet pipeline) will be issued and executed (step 92) for the packet in question. Then, once that shading has been completed (step 93), the distributing binning core will process the “finished” geometry packet to derive a bounding box for the packet and for the primitives in the packet and to cull any primitives in the packet that can be culled, etc..

For this processing, as shown in FIG. 6, first the indices for the vertices in the (completely geometry processed) geometry packet will be fetched (step 94). The vertex positions for the vertices in the packet will correspondingly be fetched (step 95), and a bounding box for the packet initialised (step 96).

The process will then build each primitive in the packet (step 97) in turn, and determine if the primitive can be culled (step 98). If a primitive is culled (step 99), then the bounding box for the primitive is set to be invalid (step 100) (to indicate that the primitive has been culled), and that (invalid) bounding box is written to the primitive packet accordingly (step 103).

On the other hand, if the primitive is not culled (step 99), then a bounding box for the primitive is determined (step 101). The bounding box for the packet is updated based on the primitive bounding box (step 102), and the bounding box for the primitive is written to the packet (step 103).

If there are more primitives in the packet, then the process is repeated until all the primitives for the packet have been processed (step 104).

Once all the primitives in the packet have been processed, then the overall bounding box for the packet is written to the packet bounding box hierarchy, as appropriate (step 105). The packet itself is then compressed and written out to memory (step 109).

As shown in FIG. 6, and as will be discussed in more detail below, in the case where the last stage of geometry shading for a packet is not being deferred (so is being performed immediately) then the packet is compressed and written to a “long-term” heap in memory (steps 106 and 107).

As shown in FIG. 6, in the case where deferred packet shading is enabled at step 91, then the process first determines a bounding box for the packet in question.

This packet bounding box can be determined in any suitable and desired manner.

This may, as discussed above, be based on and use information provided by the application that is requesting the graphics processing, and/or use appropriate position information for the packet from preceding geometry processing stages that have been performed for the packet, and/or be determined by executing an appropriate position shading (bounding box shader) for the packet that determines a bounding box for the packet (but does not otherwise perform any geometry processing, e.g. that is to be deferred for the packet).

In the case where the bounding box for a packet is then determined by running a bounding box shader for the packet (as shown in FIG. 6), the distributed binning core will issue the bounding box shader (step 110) and wait for the shading to be complete (step 115), and then fetch the packet bounding box that has been generated as a result of the bounding box shader (step 116).

Thus, if necessary, the deferred packet shading control triggers a process to appropriately generate a bounding box for a packet (and then fetches the bounding box for the packet). Alternatively, where the bounding box for the packet is already available, it will simply fetch the bounding box for the packet.

The deferred packet shading control 70 will then determine whether to defer the final geometry packet pipeline shading stage for the packet or not (step 111). In the present embodiment, this decision is based on whether the bounding box for the packet falls entirely within a single region of a plurality of regions that the render output has been divided into for the purposes of tracking deferred geometry processing (packet shading) (as discussed herein).

In the case that it is determined that the bounding box for the packet does not fall entirely within a single region at step 111, then the full shader is issued for the packet at step 92 and the process discussed above is followed for the packet.

On the other hand, when it is decided to defer the final geometry packet pipeline shading stage for the packet, it is then determined whether the packet whose processing is being deferred has any relevant parent packets that would be needed when performing the deferred processing (step 112). If so, the deferred packet shading control 70 causes the required parent packets to be written appropriately to memory (step 113).

As shown in FIG. 6, the distributed binning core operation will then write the packet bounding box and any other information (e.g. state) required for performing the deferred packet shading at a later time into the bounding box hierarchy structure that it is generating for the render output in question (step 114).

The process then waits for the next packet to be processed (step 90), and so on.

Once all the packets for a render output (e.g. draw call) being processed have reached the last stage of the geometry processing pipeline being executed and correspondingly being processed by a distributed binning core in the manner illustrated in FIG. 6, then the distributed binning core(s) will have generated, between them, an appropriate binning data structure or structures that can be used to determine which packets for the render output should be processed for respective rendering tiles of the render output.

In the present embodiments, the binning data structures generated by the distributed binning cores comprise appropriate bounding box hierarchies, against which respective rendering tiles can be tested to determine whether a packet should be processed for the rendering tile or not.

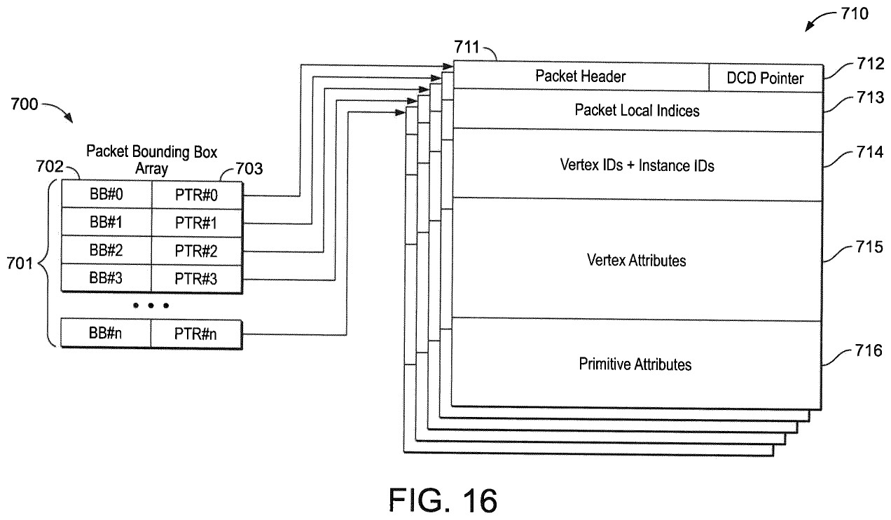

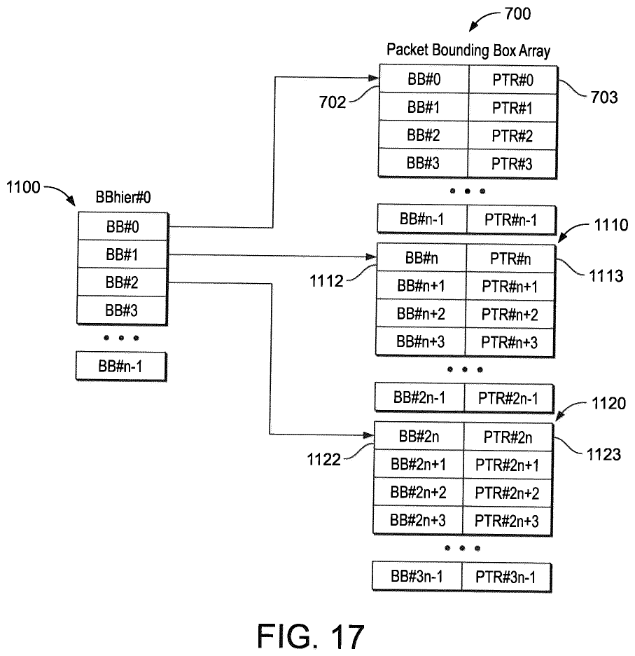

FIGS. 16 and 17, show, by way of example, a bounding box hierarchy binning data structure that may be generated in the present embodiments, in the case where all the geometry processing for all of the packets for the render output in question is (fully) completed prior to the binning stage (prior to the binning data structures being generated).

As shown in FIG. 16, the lowest level of the bounding box hierarchy comprises a packet bounding box array 700 that includes a number of entries 701 that each include a respective pointer 703 pointing to the respective packet 710 in memory, and a bounding box (bounding box information) 702 for the packet in question.

FIG. 16 also shows the memory layout and content for an exemplary packet 710 that may have been generated. As illustrated in FIG. 16, in the present embodiments, each packet 710 may include header information 711 that includes a pointer to the draw call descriptor (DCD) 712 for the draw call that the packet represents. Each packet 710 further includes body information comprising identifiers 714 for the vertices that the packet contains, and indices 713 that reference the vertices to define the primitives that the packet contains. Each packet 710 further includes vertex attribute data 715 for the vertices that the packet contains, and primitive attribute data 716 for the primitives that the packet contains.

A packet 710 may also comprise respective primitive bounding boxes for primitives contained within the packet (where they have been generated by the binning process).

Other arrangements of packet would, of course, be possible.

As shown in FIG. 17 one or more further bounding box hierarchy levels are also generated.

As illustrated in FIG. 17, a bounding box hierarchy array 1100 may be maintained, with each entry of the array comprising a pointer pointing to an array defining bounding boxes for a respective level of the bounding box hierarchy. As illustrated in FIG. 17, in this embodiment, the first entry of the bounding box hierarchy array 1100 points to the lowest level packet array 700 shown in FIG. 16.

A higher level of the bounding box hierarchy may be generated by iterating through the packet array 700 and generating from the packet bounding boxes 702, bounding boxes for groups of, e.g. two, four, eight (or another number), packets. As illustrated in FIG. 17, these (larger) bounding boxes may be stored in entries of higher-level array 1110, wherein each entry of the array 1110 comprises a respective, “higher level” bounding box 1112, and pointers 1113 pointing to the packet array 700 entries for the packet bounding boxes from which the “higher level” bounding box was generated.

Further levels of the bounding box hierarchy may be generated in an analogous manner. For example, FIG. 17 shows a higher-still level of the bounding box hierarchy generated by iterating through array 1110 and generating from the bounding boxes 1112, larger bounding boxes, which are stored in entries of array 1120, wherein each entry of the array 1120 comprises a respective, higher level bounding box 1122, and pointers 1123 pointing to the corresponding next lower level array 1110 entries. Further levels of the bounding box hierarchy may be generated up to a “highest” level which may comprise a single bounding box that encompasses all primitives of all packets, e.g. for the draw call/render output in question.

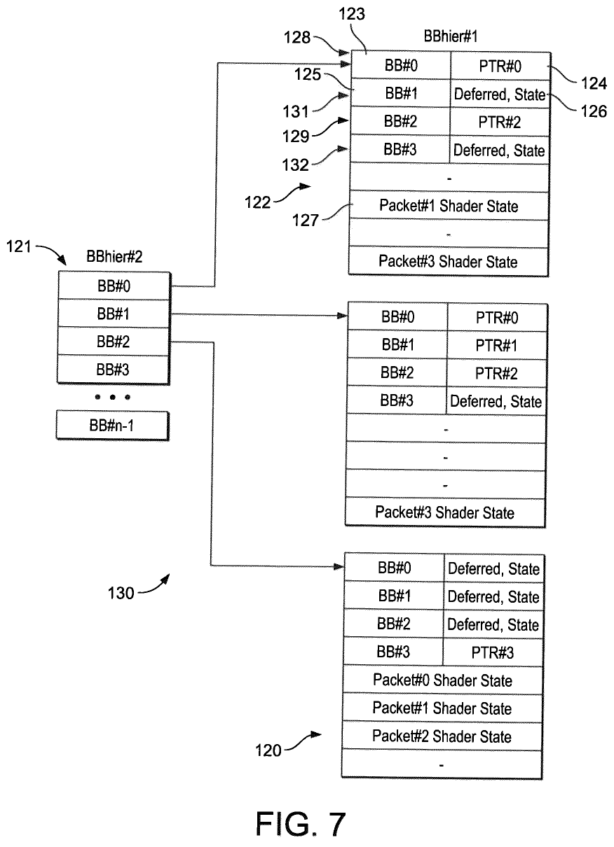

FIG. 7 shows a corresponding binning data structure 130 in the form of a bounding box hierarchy for use to determine which packets should be processed for respective rendering tiles that is generated by the distributing binning cores 49 in the present embodiments in the case where the last geometry shader stage has been deferred for some packets (so including “primitive” packets for which the geometry packet pipeline has been fully executed, and “geometry” packets for which the last stage of the geometry packet pipeline has been deferred).

As shown in FIG. 7, the bounding box hierarchy in this example includes two levels, a lower level 120 that stores bounding boxes for respective individual primitive packets, and a higher level 121 that stores bounding boxes for respective groups of primitive packets.

Thus, when using this data structure to identify primitive packets that should be processed for a rendering tile, the tile will first be tested against the higher level bounding boxes 121 to determine respective groups of primitives that (potentially) need to be processed for the tile. Then the tile will be tested against the respective individual packet bounding boxes in the appropriate lower level 120 data structure to identify those primitive packets that should be processed for the tile.

As shown in FIG. 7, the lower level bounding box hierarchy 120 stores in the case of a primitive packet for which the last stage of the geometry packet pipeline was not deferred, a bounding box 123 for the primitive packet, and a pointer 124 to where the primitive packet is stored in memory.

On the other hand, for a primitive packet whose last stage in the geometry packet pipeline was deferred, the lower level 120 of the bounding box hierarchy instead stores a bounding box 125 for the primitive packet, together with an indication 126 that the last stage of the geometry packet pipeline for that packet has been deferred, and any appropriate state, etc., 126, 127 that is required for performing the deferred shading.

Thus, as shown in FIG. 7, for a first group of four primitive packets 122, for the first and third primitive packets 128, 129 in that group, for which all of the geometry packet pipeline shading has been completed, an appropriate bounding box and a pointer to the packet in memory is stored in the binning data structure 130.

On the other hand, the second and fourth primitive packets 131, 132 have had the last stage of the geometry packet pipeline shading deferred, and so for those packets, a bounding box and an indication that the shading has been deferred, together with the appropriate shader state for performing the deferred shading, is stored.

In the present embodiments, and in accordance with the technology described herein, the amount of geometry processing to be performed at the rendering stage for respective regions of a render output being generated is tracked, and when the amount of geometry processing for a given region of the render output reaches a threshold value, rendering of the region of the render output is triggered (irrespective of whether all the geometry for the render output has been (initially) processed).

In the present embodiments, the amount of geometry processing to be performed at the rendering stage for respective regions of a render output being generated is, as will be discussed in more detail below, tracked on the basis of the amount of geometry that is determined to be present in each respective region (irrespective whether any geometry processing for the geometry in the region has actually been deferred to the rendering stage or not). Thus a total amount of geometry for each respective region is tracked and compared to a threshold value, to thereby, where appropriate, trigger rendering of the region of the render output.

Other arrangements, such as tracking an amount of geometry that has had its processing deferred, would, of course, be possible.

In order to facilitate this operation, the geometry processing pipeline 42 includes, as shown in FIG. 3, a geometry tracking unit (circuit) 50 that tracks the amount of geometry for respective regions of a render output, and that, when the amount of geometry for a region of the render output reaches a threshold value, triggers 51 (FIG. 3) rendering of the region of the render output.

As will be discussed further below, the geometry tracker 50 is also configured to trigger rendering of all regions of a render output once all the geometry for the render output has been (initially) processed (irrespective of whether the amount of geometry processing for a given region of the render output has reached the threshold or not).

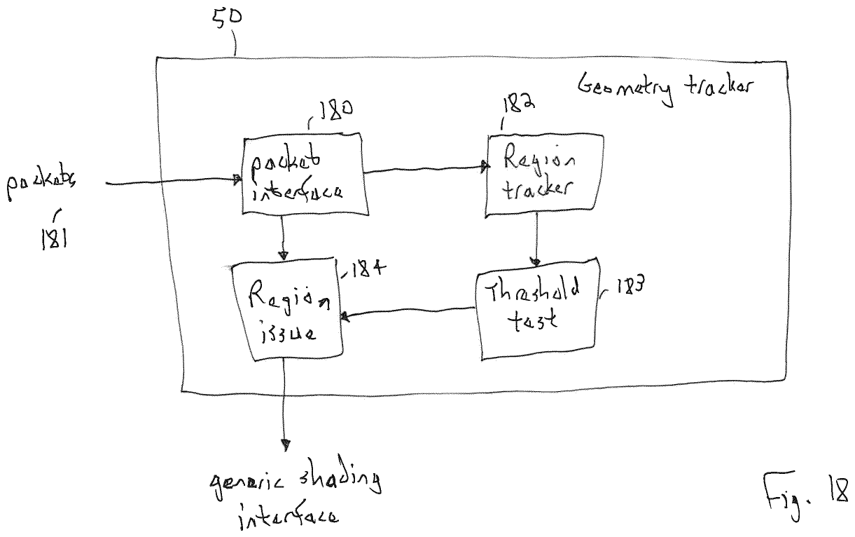

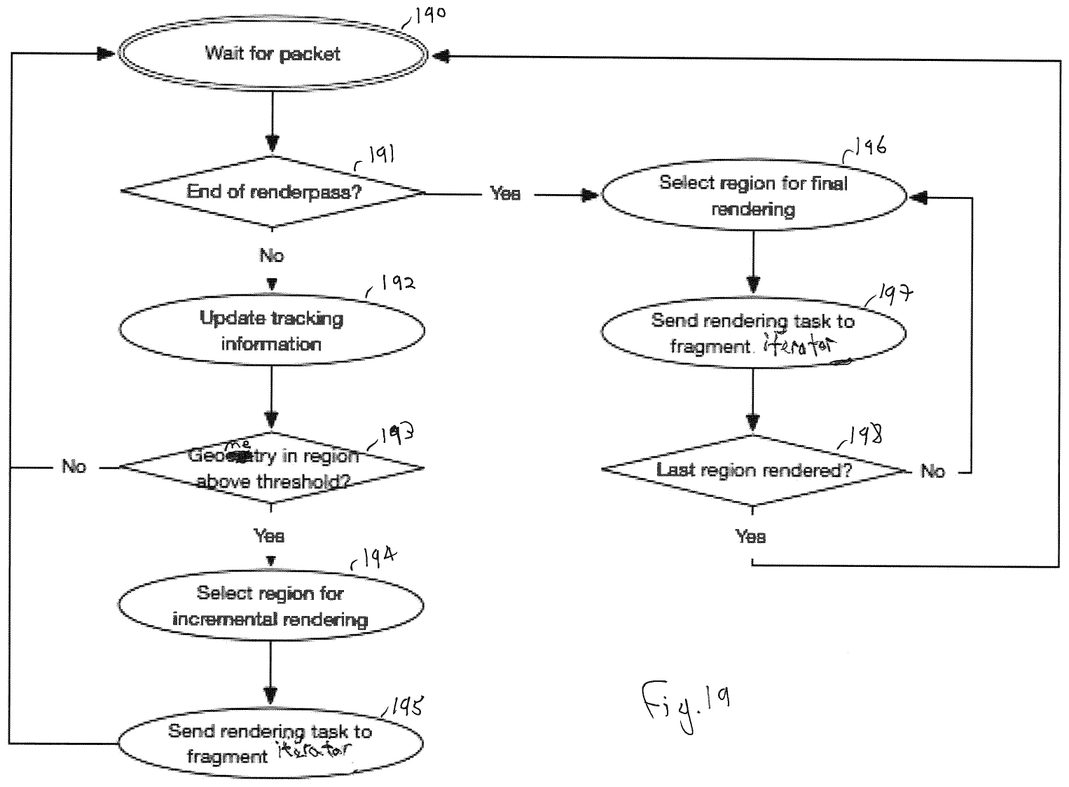

FIG. 18 shows the geometry tracker 50 of the present embodiments in more detail. FIG. 19 is a corresponding flowchart showing the operation of the geometry tracker 50 of the present embodiments.

As shown in FIG. 18, the geometry tracker unit 50 includes a packet interface 180 that receives 181 packets from the geometry packet pipeline.

When the packet interface 180 receives a packet from the geometry processing pipeline (step 190, FIG. 19), the packet interface 180 first determines whether the packet indicates that the end of the current render pass (render output) has been reached (step 191, FIG. 19).

In the event that the end of the current render pass (render output) has not been reached, then the packet interface sends the relevant packet information, including at least a bounding box and amount of primitives for the packet, to a region tracker 182 (FIG. 18), for the region tracker to update its tracking of how much geometry there is for respective regions of the render output being generated.

In the present embodiments, the region tracker 182 maintains a count of how many primitives there are for respective regions of a render output being generated. Thus, the region tracker 182 maintains, for each region that a render output has been divided into in this regard, a count of the (current) number of primitives for the region.

Other arrangements, such as counting the number of packets for the regions, would be possible, if desired.

In the present embodiments, a render output is divided into a plurality of equally sized and shaped regions for this purpose, with each region corresponding to a set of one or more (contiguous) rendering tiles. For example, each region could correspond to a single rendering tile, or to a group of plural rendering tiles, etc., as desired. For each such region, a corresponding “primitive”count is maintained.

When the region tracker 182 receives information about a packet from the packet interface 180, it first determines which region (or regions) of the render output the packet falls within (e.g., and in an embodiment, by comparing a bounding box for the packet with the locations of the regions that the render output has been divided into), and then updates the corresponding counter for the region (or regions) that it has been determined the packet falls within (step 192, FIG. 19) (based on the number of primitives in the packet in question, for example).

A threshold test unit 183 then determines whether the incremented count for the region or regions in question now exceeds a threshold count of primitives for the region or regions in question (step 193, FIG. 19).

In the present embodiments, the primitive count threshold is based on the (estimated) amount of data that would be generated and accordingly need to be stored at the rendering stage when performing the (deferred) geometry processing for the packets. In particular, a threshold maximum amount of data capacity for performing (deferred) geometry processing for a region of the render output is set, in terms of a permitted maximum number of primitives for a given region of a render output (based on a local storage capacity of the graphics processor for storing data when performing deferred geometry shading for a render output region and an estimate of the likely amount of data that will be produced when performing deferred geometry shading for a given number of primitives).

As shown in FIG. 19, if the incremented count of primitives for a region does not exceed the set threshold, then the process simply waits for the next packet.

On the other hand, when the threshold test 183 determines at step 193 that the count of primitives for a region has reached the permitted threshold count, then rendering of the region in question is triggered (it is determined that the region should be rendered) (step 194 of FIG. 19).

To trigger the rendering for the region, as shown in FIG. 18, the threshold test circuit 183 signals a region issue circuit 184, which then correspondingly sends an appropriate rendering task (command) to trigger the rendering of the region to the fragment iterator 41 of the job control unit 39 via the generic shading interface 47 to cause the appropriate tasks for sending to the fragment end points 38 of the shader cores 32 to perform the necessary fragment shading to render the region of the render output to be generated (step 195, FIG. 19).

The rendering task (command) that is sent to trigger the rendering of the region in this case indicates, inter alia, the region of the render output that the rendering task applies to, and that the rendering task is for an “incremental” render for the region (and whether it is the first or a subsequent incremental render for the region in question), so that the rendering for the region can be performed appropriately (e.g., and in an embodiment, combined with any preceding incremental render for the region in question, and stored as an incremental (intermediate) rendering output for the region so as to be available to be combined with further renders of the region in question).

The geometry tracking record (the primitive count) for the region that is sent for rendering is also correspondingly cleared (reset), so that a new count for the region for the render output in question can be begun.

The operation will then wait for the next packet for the render output in question (step 190, FIG. 19).

This operation will be repeated for each and every packet that is generated by the geometry processing pipeline for the render output in question, until the end of the render output (render pass) is reached.

As shown in FIG. 19, when the end of the render pass (render output) is reached, then the packet interface 180 operates to signal that to the region issue unit 184 (step 191, FIG. 19).

In response to this, the region issue unit 184 sends each region for the render output in question for any final rendering in turn (steps 196, 197 and 198, FIG. 19).

Again, the region issue unit 184 sends an appropriate rendering task (command) to trigger the “final” rendering of the (each) region in question. In this case, the rendering task (command) correspondingly indicates the region in question and that this is the “final” render for the region for the render output in question (so that, for example, the output of the render for the region can be appropriately output as the final rendering result for the render output for the region in question).

This then has the effect of completing any outstanding rendering for the render output in question, once all the geometry for the render output (the render pass in question) has been processed.

The geometry tracking (the region counters) for the render output in question is also cleared (discarded).

The process will then be repeated for the next render output (render pass), and so on.

In the present embodiments, the geometry tracker 50 triggers rendering of a region of a render output (whether that is because the amount of deferred geometry for a region has exceeded the threshold, or the end of a render output (render pass) has been reached), by sending an appropriate rendering task 51 to the fragment iterator 41, via the generic shading interface 47 (as shown in FIG. 3, for example).

The rendering/fragment processing of the render output region is then triggered and controlled by the fragment iterator 41 issuing appropriate fragment shading (rendering) tasks to the fragment endpoints 38 of the shader cores, with the fragment endpoints then triggering appropriate fragment shading, etc., on the execution cores, accordingly.

In the present embodiments, the triggering and control of the rendering/fragment shading by the fragment iterator is also operable to determine whether any geometry shading has been deferred for packets to be processed for a region, and to, if so, trigger the performance of the deferred geometry processing for a packet, before the rendering/fragment processing for a region using the packet is performed.

To facilitate this, in the present embodiments, the fragment iterator includes a deferred shading control unit (circuit) 8130, that receives appropriate commands (rendering task commands) from the geometry tracker 50 to perform rendering/fragment processing for a region of a render output, and which, in response to those commands, determines whether deferred geometry shading has been enabled, and if so, then determines whether any deferred geometry shading for packets for the region of the render output needs to be performed before rendering/fragment shading is performed.

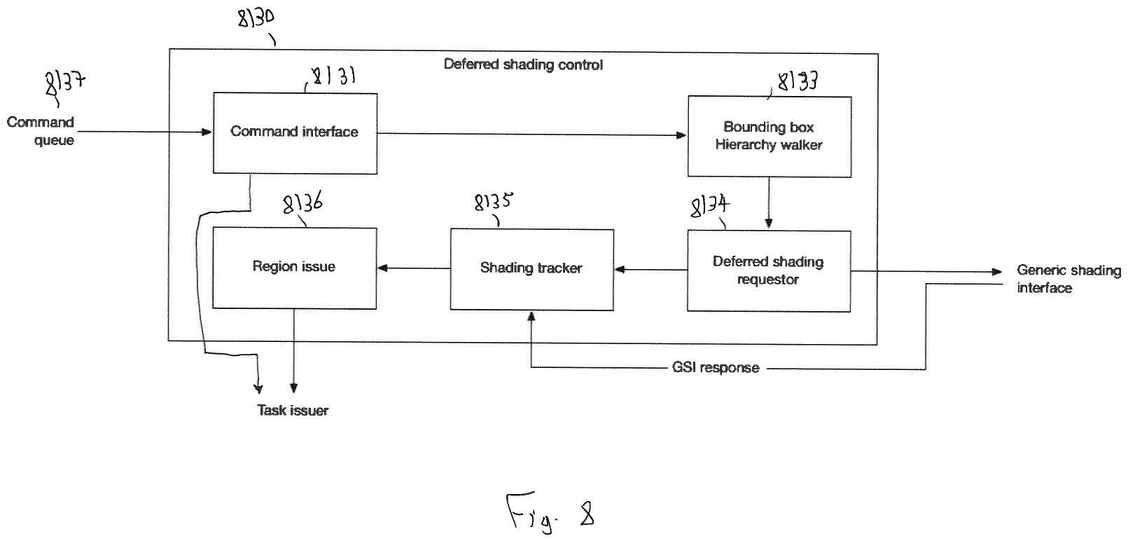

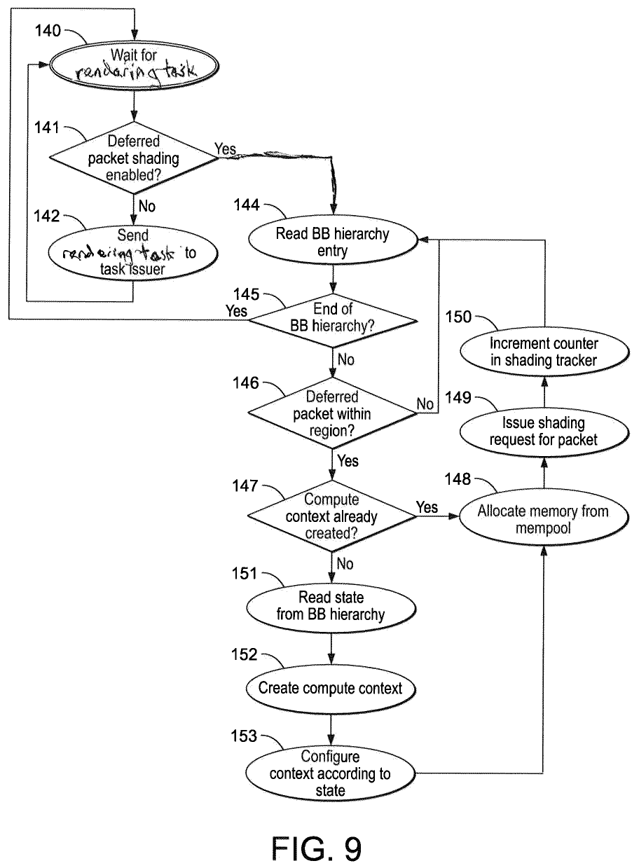

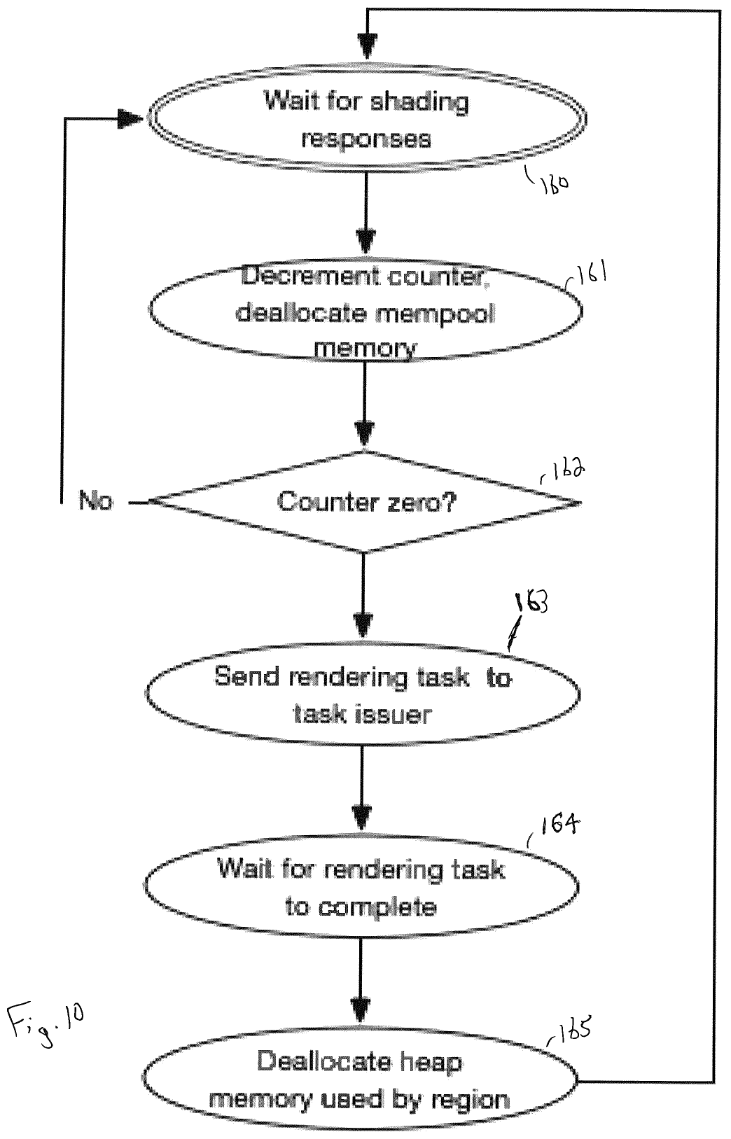

FIG. 8 shows the deferred shading control unit 8130 of the present embodiments in more detail. FIGS. 9 and 10 are corresponding flowcharts showing the operation of the deferred shading control unit of the present embodiments.

As shown in FIG. 8, the deferred shading control unit 8130 includes a command interface 8131 that receives appropriate rendering/fragment shading commands from a command queue 8137.

When the command interface 8131 receives a rendering task command (thereby indicating that fragment shading for a region of a render output should be performed) (step 140, FIG. 9), the command interface 8131 (FIG. 8) first determines whether deferred packet (geometry) shading has been enabled (step 141, FIG. 9).

In the event that deferred packet shading has not been enabled, then the command interface simply sends the rendering task command directly to a task issuer that generates the appropriate tasks for sending to the fragment endpoints 38 of the shader cores 32 to perform the necessary fragment shading to render the region of the render output (step 142, FIG. 9).

On the other hand, in the event that deferred geometry shading for packets has been enabled, then the command interface 8131 signals a bounding box hierarchy walker 8133 to walk the binning bounding box hierarchy to identify any packets for the region for which the geometry processing has been deferred.

The bounding box hierarchy walker (walking circuit) 8133 (FIG. 8) traverses the bounding box hierarchy binning data structure generated by the distributed binning cores to determine those geometry/primitive packets that apply to the render output region in question and whether any of those packets have had their geometry processing deferred (steps 144, 145 and 146 in FIG. 9).

When a packet applying to a region for which the geometry processing has been deferred is identified at step 146, the appropriate geometry processing for that packet is triggered by a deferred shading requester circuit 8134 (see FIG. 8) of the deferred shading control unit 8130. (For any packets applying to the region for which geometry processing has been deferred, the appropriate deferred shading operation is triggered (issued) by the deferred shading requester 8134.) When deferred geometry processing for the packet is to be performed, as shown in FIG. 9 it is first determined whether the appropriate compute shading context has already been created (step 147).

If so, an appropriate memory allocation is allocated for the result of the geometry processing of the packet (step 148), the appropriate geometry shading request for the packet is issued (step 149) and a counter in a geometry processing shading tracker 8135 is incremented (step 150) (this counter is used to track and determine when all the packets within the region being considered have had their deferred geometry processing completed).

In the case where the compute context for the deferred geometry shading has not already been created (step 147), then the appropriate compute shading state is read from the bounding box hierarchy binning data structure (step 151), the appropriate compute shading context is created (step 152), and configured according to the read state for the packet in question (step 153).

Then, again, appropriate memory is allocated, a shading request for the packet is issued, and the shading tracker counter is incremented (steps 148, 149 and 150).

In the present embodiments, the deferred geometry shading for a packet is triggered and controlled by sending a shading request for the packet to the distributed binning control of a shader core, for the distributed binning core of the shader core to then trigger the deferred geometry shading for the packet in question and then generate an appropriate processed packet and updated binning data structure (bounding box hierarchy) for the processed (and shaded) packet. This operation is performed in the manner discussed above with reference to FIG. 6 (in the case where deferred packet shading is not enabled at step 91).

Thus, in this case, when the packet for which deferred geometry shading is to be performed is sent to a distributed binning core at the rendering stage, the distributed binning core will first issue the deferred geometry shading for the packet (step 92), and then when that shading is complete (step 93) process the packet in the manner discussed above with reference to FIG. 6 to generate the appropriate primitive packet (steps 94-105) and update the corresponding binning data structure (bounding box hierarchy) accordingly. The binning stage also in an embodiment correspondingly sets the packet as not (as no longer) having any geometry processing “deferred” for it in the updated binning structure, so that when the updated binning structure is used, the packet will be seen as being “complete”, and not needing further geometry processing to be performed for it (as that further geometry processing will now have been done).

As shown in FIG. 6, in this case, as the processing is being performed at the deferred shading point (step 106), the processed packet that has been generated by the distributed binning core after the deferred shading has been performed is stored in a “short-lived” heap in memory (steps 108 and 109) (rather than being stored in a longer-term memory heap).

As shown in FIG. 9, the process then continues to read further entries in the bounding box hierarchy binning data structure to identify all packets in the region for which geometry processing has been deferred and to trigger that geometry processing appropriately.

A shading tracker (circuit) 8135 for the deferred shading control unit 8130 maintains appropriate counters to track the packets for which deferred geometry shading is being performed for a region, and to correspondingly track when all the deferred geometry processing of packets for the region has been completed. To facilitate this, as shown in FIG. 8, the shading tracker 8135 will receive responses from the shader cores indicating when the deferred geometry processing for a packet has been completed, so that it can then decrement the corresponding region counter.

Once a deferred geometry shading counter for a region has been decremented to 0, that is taken as indicating that the geometry processing for all the deferred packets in the region has been completed, such that the geometry processing will then have been completed for all the packets for the region in question, such that the fragment processing (rendering) for the region can proceed. This is signalled to an appropriate region issue circuit 8136 (FIG. 8), which issues an appropriate “region” rendering task command to the task issuer for the task issuer to issue appropriate fragment processing tasks for the region in question.

FIG. 10 illustrates this operation and shows that in response to geometry shading completion responses received from the shader cores, the shading tracker 8135 will decrement the appropriate region deferred geometry shading tracking counter (steps 160, 161) and when the counter for a region is 0 (step 162), generate a rendering task command for the region in question and send that rendering task command to the task issuer (step 163). Then, once the fragment shading for the region has been completed (step 164), the memory allocation used for the region in question will be deallocated (step 165).

This process will be performed each time the deferred geometry shading for packets for a render output region has been completed, so as to trigger the appropriate fragment shading for the region of the render output.

Although the present embodiments show the deferred shading control unit 8130 as being part of the fragment iterator in the job control unit 39, that deferred shading control unit and process can be located and performed elsewhere in the graphics processor, if desired. For example, it could be part of (e.g. at the end of) the geometry packet pipeline, if desired.

Once an appropriate rendering task command has been sent to the task issuer, the task issuer will then issue appropriate rendering/fragment processing tasks to the fragment endpoints 38 of the shader cores 32 for respective rendering tiles accordingly.

The tasks will indicate an appropriate set of one or more tiles to be rendered by the shader core in question, together with an indication of the rendering/fragment processing that is to be performed for the tiles. The fragment endpoint 38 will then use the binning data structures generated by the distributed binning cores to identify the packets and primitives to be processed for a tile that they are processing, and perform appropriate rendering/fragment processing for the primitives in question for the tile in question.

The rendering/fragment processing that is performed for primitives and for a tile can comprise any suitable and desired rendering/fragment processing that can be performed, such as rasterising primitives to fragments and then performing fragment shading for the fragments, and/or performing ray tracing operations, etc..

Once a shader core has processed a tile, that tile will be written out to storage and the shader core will process the next tile (if any) that it is to process, and so on. This will be continued until all the tiles for the render output region in question have been entirely generated.

This process will then be repeated for the next render output region, and so on, as appropriate.

As discussed above with reference to FIG. 6, for example, in the present embodiments, the memory heap that is used for storing the packets that have been processed in the technology described herein is configured and used as two separate “sub-heaps”, one heap that is used to store packets that need to be retained for a longer period of time, and another heap that is used to store packets that need to be retained for a shorter period of time.

In particular, as discussed above, any packets that are generated as a result of performing deferred geometry processing at the rendering stage are, preferentially, stored in a “short-lived” heap, which is allocated and used while processing a given render output region. Thus there will be a short-lived heap that is allocated for a region and used for storing any newly generated packets when performing deferred geometry shading for packets in the region when a region is being rendered, but which short-lived heap is then de-allocated once the rendering (fragment shading) for the region in question has been completed.

(When de-allocating a short-lived heap when the rendering (fragment shading) for a region has been completed, the data is in an embodiment also invalidated at that point to prevent old data from spilling into external memory.)

The other, longer-lived memory heap is in an embodiment allocated and used for a given render output being processed, and thus will be allocated and de-allocated on a per render output basis. Thus this heap will remain valid and in use whilst all of the regions for the render output in question are being processed (and will be de-allocated when the “final” render of the last region for the render output in question has been completed).

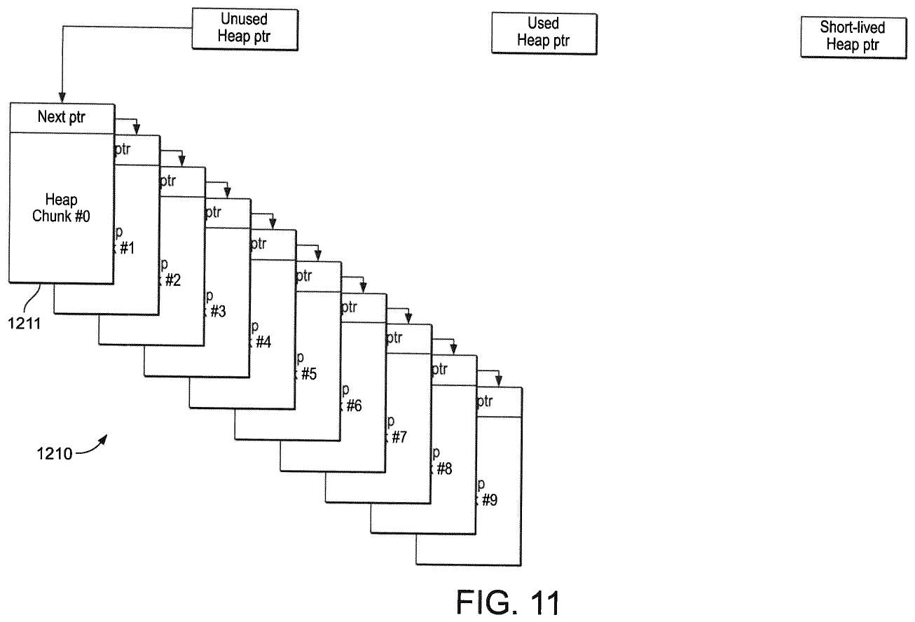

FIGS. 11-14 illustrate this.

As shown in FIG. 11, the memory heap 1210 that will be used for storing the packets in the present embodiments is organised as an appropriately linked sequence of heap “chunks” 1211. When a memory allocation for storing packets is required, then appropriate allocation of heap chunks will be requested.

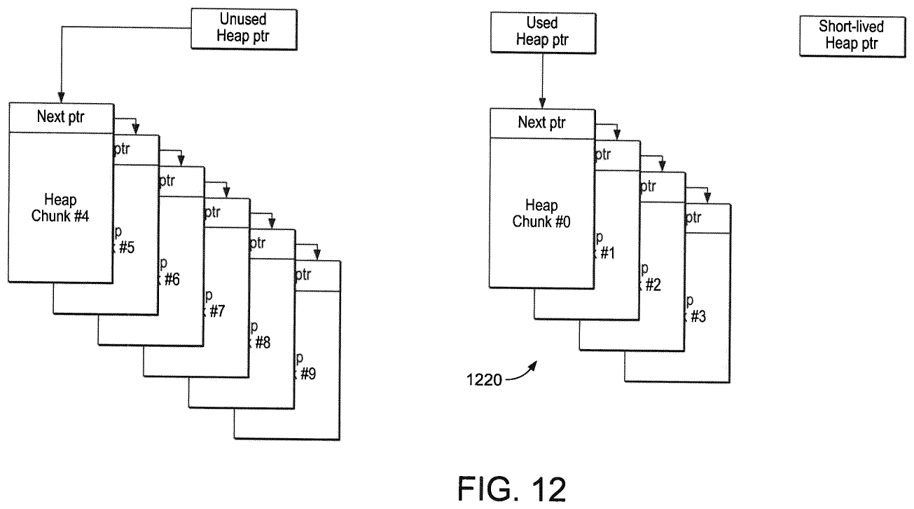

As shown in FIG. 12, when performing the initial (not-deferred) geometry processing, appropriate heap chunks will be allocated to a “long-lived” heap 1220 for storing the packets that are generated by the geometry processing pipeline. These packets and heap chunks will remain valid and in use until the rendering for the render output in question has finished. Thus the “long-lived” heap 1220 will be used to store primitive packets for which the geometry processing and binning processing has been completed at the binning stage, together with the appropriate bounding box hierarchy binning data structure or structures. Any “input” packets that are required for performing any deferred geometry processing are also stored in the “long-lived” heap.

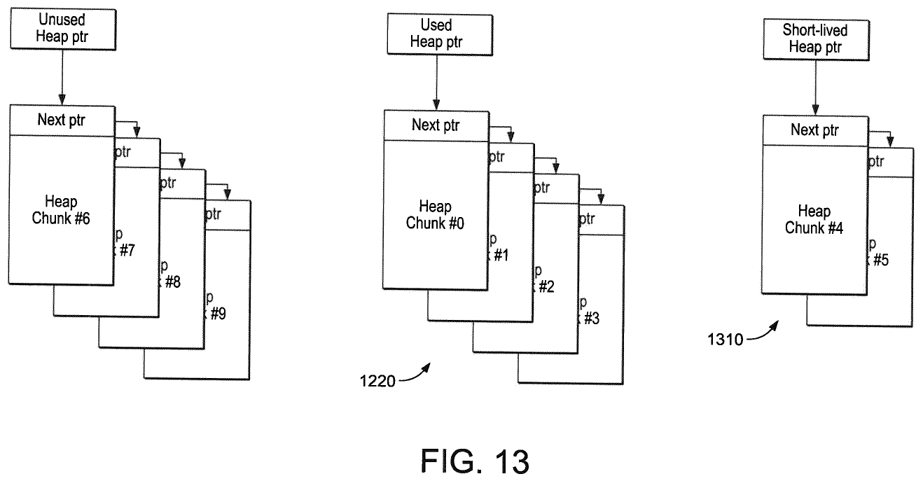

As shown in FIG. 13, when deferred geometry processing is being performed at the rendering stage, appropriate heap chunks will be allocated for storing the processed packets from that geometry processing in a “short-lived” heap 1310, which will be de-allocated once the rendering for the render output region in question has been completed.

Once the rendering (fragment processing) of a region has been completed, the heap chunks in the short-lived heap 1310 are de-allocated and circulated back to the unused heap chunks for re-use.

Once the entire render output has been completed, then the heap chunks in the “long-lived” heap 1220 are de-allocated and circulated back to the unused heap chunks for reuse.

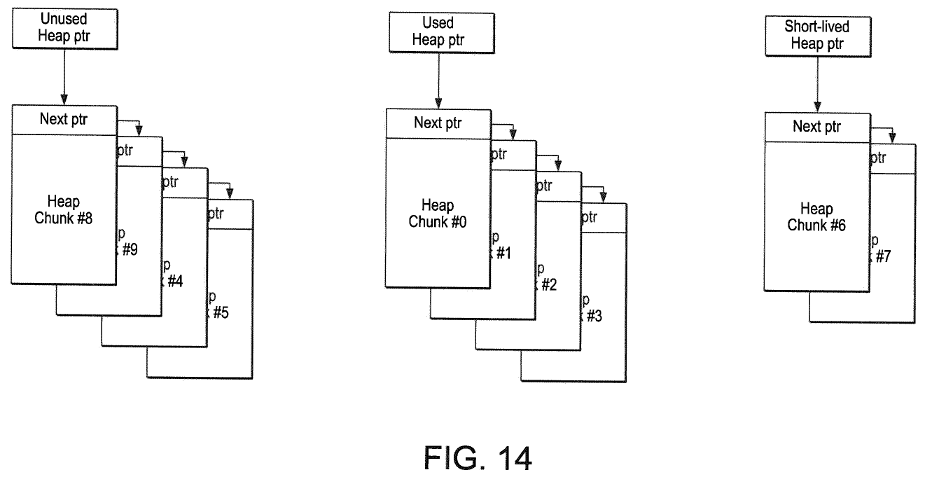

FIG. 14 illustrates this and shows, for example, the heap usage for a next region being processed. Thus in this case, the heap chunks in the short-lived heap for the previous region have been returned to the unused heap chunks for reuse, and new heap chunks have been assigned to a short-lived heap for use for the region now being processed.

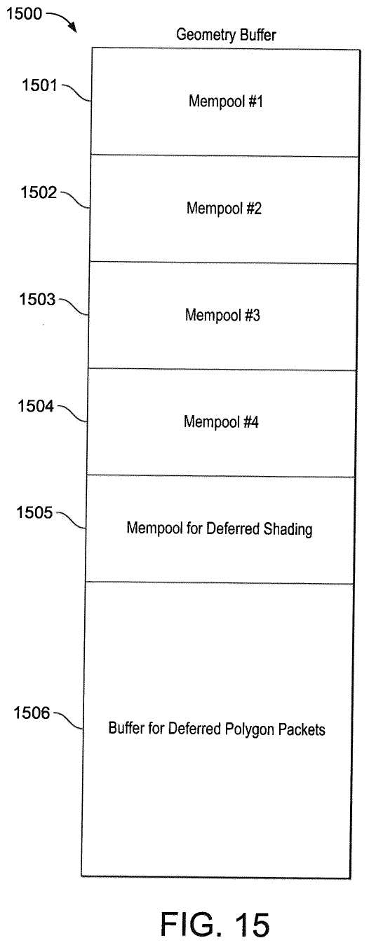

FIG. 15 shows an exemplary layout of the geometry buffer where the various data is stored in the present embodiment (which geometry buffer will use heap chunks as illustrated in FIGS. 11-14).

As shown in FIG. 15, the geometry buffer 1500 may include, e.g. four memory pools 1501, 1502, 1503 and 1504 that are used by the geometry packet pipeline during processing of the geometry. There is then a further memory pool 1505 that is used for geometry packets when performing deferred geometry shading, and a buffer 1506 for storing processed primitive packets created from deferred geometry shaded packets. The size of this buffer 1506 may set the limit for the threshold number of primitives for a region before rendering of the region is triggered.

It will be appreciated from the above that in the operation of the present embodiments, respective regions of a render output for which the amount of geometry processing is being tracked may undergo zero or more incremental renders when generating a given render output, in dependence upon how much geometry for the render output is present in different regions of the render output. The effect of this then may be, for example, that some regions of a render output will undergo one or more incremental renders while the render output is being processed, whereas other regions may simply undergo a “final” render when the end of the render output is reached.

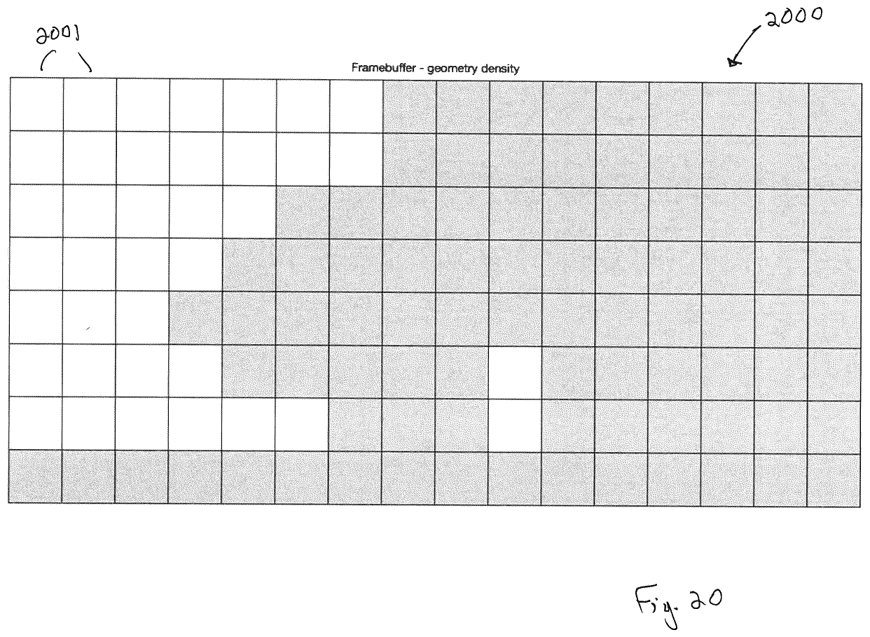

FIGS. 20 to 23 illustrate this, and show an exemplary render output 2000 divided into respective regions 2001 for which the amount of geometry for the region is tracked. In these Figures, the darker regions indicate regions where there is a greater amount of geometry and vice-versa.

FIG. 20 shows an exemplary region geometry tracking situation after starting processing a render output. In FIG. 20 it is assumed that some regions (the white regions) have no geometry so far for the render output, whereas the grey regions contain geometry (but less than the threshold amount of geometry).

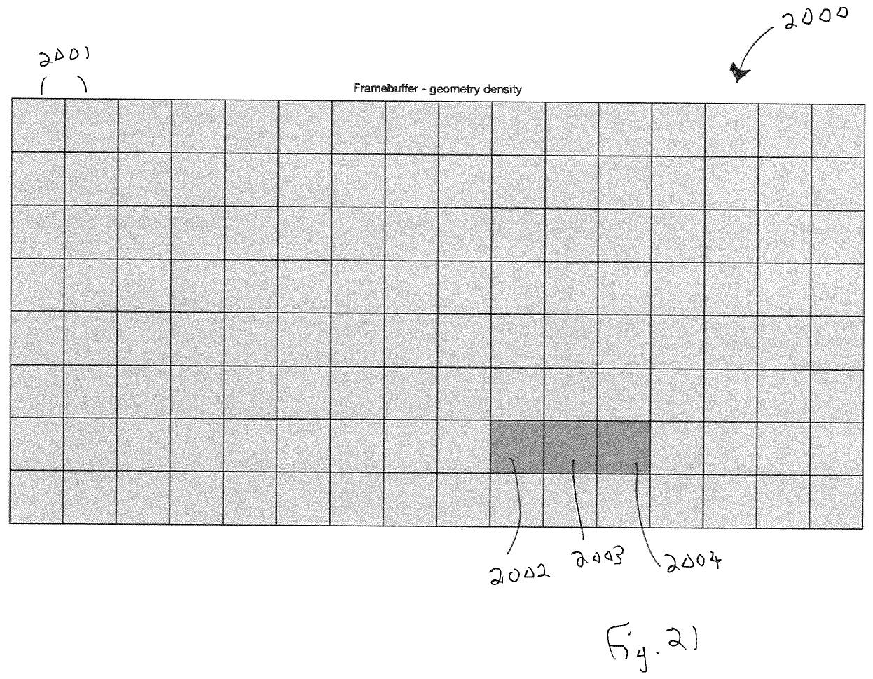

FIG. 21 shows the region tracking status after more geometry has been processed for the render output. In this case, it is assumed that all the regions now contain at least some geometry, and three regions 2002, 2003 and 2004 have reached the threshold amount of geometry for triggering rendering of the region in question. Those regions 2002, 2003 and 2004 will accordingly be sent for (incremental) rendering.

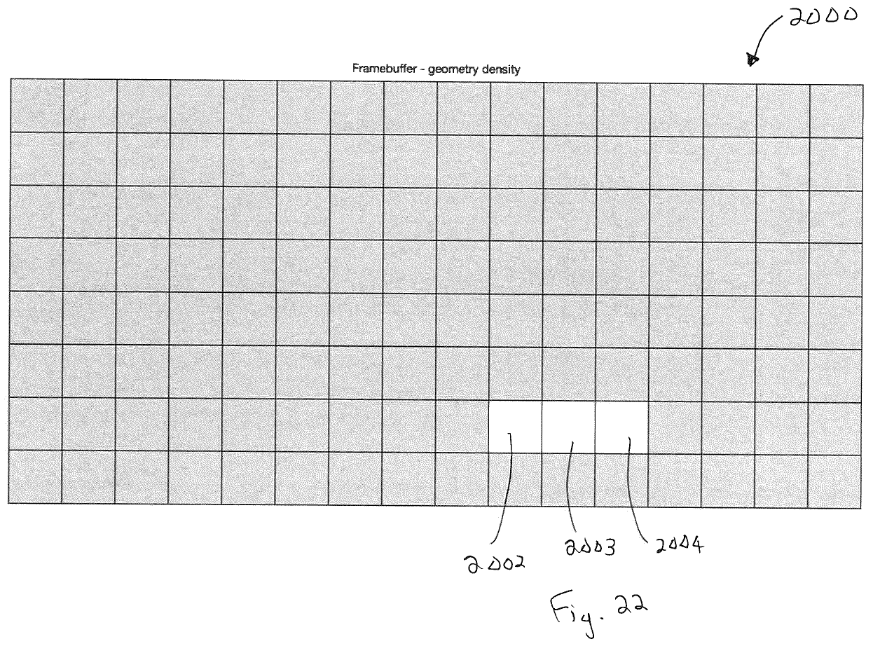

FIG. 22 shows the region tracking status after the regions 2002, 2003 and 2004 have been incrementally rendered. As shown in FIG. 22, the geometry tracking for the regions 2002, 2003, 2004 that have been sent for incremental rendering is reset after the incremental rendering has been completed, such that those regions are now showing as having no geometry currently to be processed for them.

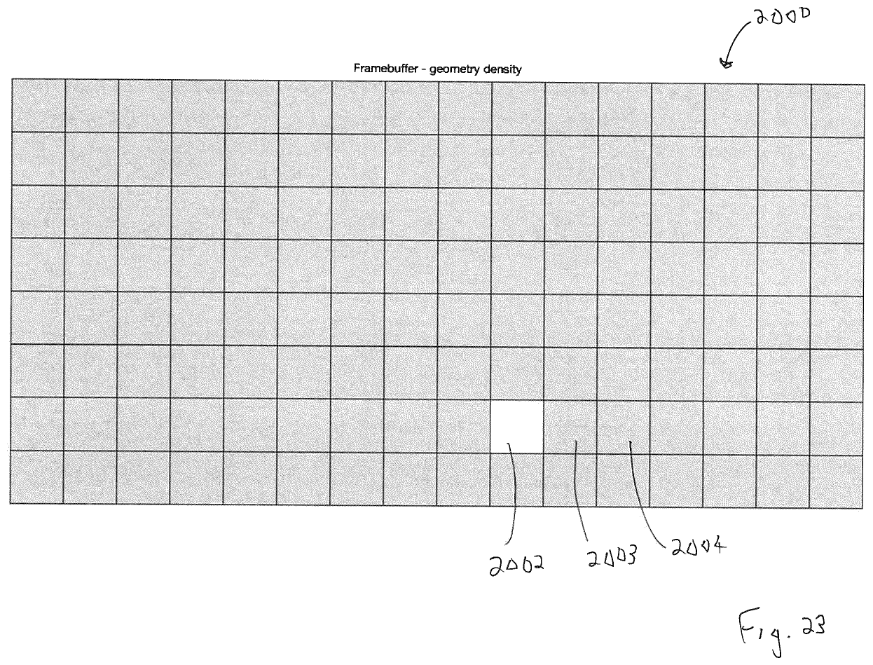

FIG. 23 shows an exemplary region tracking status when the end of the geometry processing for the render output (for the render pass) is reached. As discussed above, in this case at least those regions that have outstanding geometry will be sent for a “final” render.

In the example shown in FIG. 23, it is assumed that all regions except for region 2002 have outstanding geometry to be processed and so will be sent for a final rendering operation. The final rendering operation may be omitted for region 2002 which does not have any outstanding geometry, if desired. (The remaining regions will have somewhere between zero and the threshold amount of geometry outstanding to be processed.)

Although the present embodiments have been described above with reference to the generation of geometry packets and the possibility of deferring geometry processing for respective geometry packets, it will be appreciated by those skilled in the art that the deferral (or not) of geometry processing could be considered and applied in relation to other “units” of geometry, such as for example, for individual primitives. For example, it could be determined to defer vertex shading for respective individual primitives until the rendering stage, if desired.

As will be appreciated from the above, the technology described herein, in its embodiments at least, can provide improved tile-based graphics processing pipeline operation, in particular in the case where geometry processing can be deferred until the rendering stage. This is achieved, in the embodiments of the technology described herein at least, by tracking an amount of geometry for respective regions of a render output, and when the amount of geometry for a region of a render output reaches a threshold value, triggering (incremental) rendering of the region of the render output.

Whilst the foregoing detailed description has been presented for the purposes of illustration and description, it is not intended to be exhaustive or to limit the technology described herein to the precise form disclosed. Many modifications and variations are possible in the light of the above teaching. The described embodiments were chosen in order to best explain the principles of the technology described herein and its practical applications, to thereby enable others skilled in the art to best utilise the technology described herein, in various embodiments and with various modifications as are suited to the particular use contemplated. It is intended that the scope be defined by the claims appended hereto.

1. A method of operating a graphics processor when executing a tile-based graphics processing pipeline to generate an output, the graphics processing pipeline being executed comprising:
a sequence of one or more geometry processing stages to perform geometry processing;
a binning stage that generates data structures for identifying geometry to be processed for respective rendering tiles of a render output being generated; and
a rendering stage for rendering tiles of a render output being generated;
wherein:
some of the geometry processing of the sequence of one or more geometry processing stages of the graphics processing pipeline being executed can be deferred until the rendering stage for geometry being processed;
the method comprising:
when generating a render output:
for each region of a plurality of regions that the render output has been divided into, tracking an amount of geometry processing to be performed at the rendering stage for the region; and
when the amount of geometry processing to be performed at the rendering stage for a region reaches a threshold value, triggering the rendering of geometry for the region.

2. The method of claim 1, wherein the render output is divided into a plurality of equally sized and the same shape regions for tracking purposes.

3. The method of claim 1, wherein the threshold of geometry processing that triggers the rendering of geometry for a region is based on an amount of data that can be stored in local storage of the graphics processor when performing geometry processing for a region at the rendering stage.

4. The method of claim 1, wherein:
the tracking an amount of geometry processing to be performed at the rendering stage for a region, and the triggering the rendering of geometry for a region when the amount of geometry processing to be performed at the rendering stage for a region reaches a threshold value, comprise:
tracking an amount of geometry for a region; and
triggering the rendering of geometry for a region when the amount of geometry for the region reaches a threshold value.

5. The method of claim 1, wherein:
the tracking an amount of geometry processing to be performed at the rendering stage for a region, and the triggering the rendering of geometry for a region when the amount of geometry processing to be performed at the rendering stage for a region reaches a threshold value, comprise:
tracking an amount of geometry processing that has been deferred to the rendering stage for a region; and
triggering the rendering of geometry for a region when the amount of geometry processing that has been deferred to the rendering stage for the region reaches a threshold value.

6. The method of claim 1, further comprising:
when triggering rendering of a render output region when the amount of geometry processing to be performed at the rendering stage for a region reaches a threshold value, indicating that the rendering for the region that is triggered is rendering that has been triggered by the amount of geometry processing for the region reaching a threshold value.

7. The method of claim 1, further comprising:
when the amount of geometry processing to be performed at the rendering stage for a region reaches a threshold value, as well as triggering rendering of geometry for the region, restarting the tracking of the amount of geometry processing to be performed at the rendering stage for the region.

8. The method of claim 1, further comprising:
when the end of the geometry for a render output is reached, triggering the rendering of geometry at least for any region of the render output for which there is geometry still to be rendered.

9. The method of claim 1, wherein
the geometry processing generates packets that each store data for a set of one or more primitives to be processed for the render output; and
the geometry processing is deferred for and in respect of individual geometry packets.

10. The method of claim 1, wherein the render output comprises a draw call.

11. A graphics processor comprising:
processing circuits configured to execute a tile-based graphics processing pipeline to generate an output, the graphics processing pipeline being executed comprising:
a sequence of one or more geometry processing stages to perform geometry processing;
a binning stage that generates data structures for identifying geometry to be processed for respective rendering tiles of a render output being generated; and
a rendering stage for rendering tiles of a render output being generated;
wherein:
some of the geometry processing of the sequence of one or more geometry processing stages of the graphics processing pipeline being executed can be deferred until the rendering stage for geometry being processed;
the graphics processor further comprising:
a processing circuit configured to, when the graphics processor is generating a render output:
track, for each region of a plurality of regions that the render output has been divided into, an amount of geometry processing to be performed at the rendering stage for the region; and
when the amount of geometry processing to be performed at the rendering stage for a region reaches a threshold value, trigger the rendering of geometry for the region.

12. The graphics processor of claim 11, wherein the render output is divided into a plurality of equally sized and the same shape regions for tracking purposes.

13. The graphics processor of claim 11, wherein the threshold of geometry processing that triggers the rendering of geometry for a region is based on an amount of data that can be stored in local storage of the graphics processor when performing geometry processing for a region at the rendering stage.

14. The graphics processor of claim 11, wherein:
the tracking an amount of geometry processing to be performed at the rendering stage for a region, and the triggering the rendering of geometry for a region when the amount of geometry processing to be performed at the rendering stage for a region reaches a threshold value, comprise:
tracking an amount of geometry for a region; and
triggering the rendering of geometry for a region when the amount of geometry for the region reaches a threshold value.

15. The graphics processor of claim 11, wherein:
the tracking an amount of geometry processing to be performed at the rendering stage for a region, and the triggering the rendering of geometry for a region when the amount of geometry processing to be performed at the rendering stage for a region reaches a threshold value, comprise:
tracking an amount of geometry processing that has been deferred to the rendering stage for a region; and
triggering the rendering of geometry for a region when the amount of geometry processing that has been deferred to the rendering stage for the region reaches a threshold value.

16. The graphics processor of claim 11, wherein the processing circuit is configured to:
when triggering rendering of a render output region when the amount of geometry processing to be performed at the rendering stage for a region reaches a threshold value, indicate that the rendering for the region that is triggered is rendering that has been triggered by the amount of geometry processing for the region reaching a threshold value.

17. The graphics processor of claim 11, wherein the processing circuit is configured to:
when the amount of geometry processing to be performed at the rendering stage for a region reaches a threshold value, as well as triggering rendering of geometry for the region, restart the tracking of the amount of geometry processing to be performed at the rendering stage for the region.

18. The graphics processor of claim 11, wherein the processing circuit is configured to:
when the end of the geometry for a render output is reached, trigger the rendering of geometry at least for any region of the render output for which there is geometry still to be rendered.

19. The graphics processor of claim 11, wherein:
the geometry processing generates packets that each store data for a set of one or more primitives to be processed for the render output; and
the geometry processing is deferred for and in respect of individual geometry packets.

20. A non-transitory computer readable storage medium storing computer software code which when executing on at least one processor, performs a method of operating a graphics processor when executing a tile based graphics processing pipeline to generate an output, the graphics processing pipeline being executed comprising:
a sequence of one or more geometry processing stages to perform geometry processing;
a binning stage that generates data structures for identifying geometry to be processed for respective rendering tiles of a render output being generated; and
a rendering stage for rendering tiles of a render output being generated;
wherein:
some of the geometry processing of the sequence of one or more geometry processing stages of the graphics processing pipeline being executed can be deferred until the rendering stage for geometry being processed;
the method comprising:
when generating a render output:
for each region of a plurality of regions that the render output has been divided into, tracking an amount of geometry processing to be performed at the rendering stage for the region; and
when the amount of geometry processing to be performed at the rendering stage for a region reaches a threshold value, triggering the rendering of geometry for the region.
